(19) United States
(12) Patent Application Publication
(10) Pub. No.: US 2025/0024489 A1
(43) Pub. Date: Jan. 16, 2025

(54) MULTIMEDIA PRIORITY SERVICE OVER WIRELESS LOCAL AREA NETWORK

(71) Applicant: Apple Inc., Cupertino, CA (US)

(72) Inventors: Vivek G. Gupta, San Jose, CA (US); Haijing Hu, Los Gatos, CA (US)

(73) Assignee: Apple Inc., Cupertino, CA (US)

(21) Appl. No.: 18/744,474

(22) Filed: Jun. 14, 2024

Related U.S. Application Data
(60) Provisional application No. 63/513,774, filed on Jul. 14, 2023.

(51) Int. Cl. H04W 72/566; H04W 8/18; H04W 12/06; H04W 84/12

(52) U.S. Cl. CPC H04W 72/566; H04W 8/18; H04W 12/06; H04W 84/12

(57) ABSTRACT

The present application relates to devices and components including apparatus, systems, and methods to provide multimedia priority service (MPS) prioritization for a network via wireless local area network (WLAN) access.

### CROSS-REFERENCE TO RELATED APPLICATIONS

This application claims priority to U.S. provisional application No. 63/513,774, entitled “Multimedia Priority Service over Wireless Local Area Network,” filed on Jul. 14, 2023, the disclosure of which is incorporated by reference herein in its entirety for all purposes.

### TECHNICAL FIELD

The present application relates to the field of wireless technologies and, in particular, to multimedia priority service over wireless local area network.

### BACKGROUND

Third Generation Partnership Project (3GPP) networks utilize core networks to provide services to users. As the 3GPP networks have developed additional ways have developed for accessing the core networks to provide services to the users. One of the ways that users can access the core networks is through wireless local area networks (WLANs). The WLANs can be hosted in multiple locations, and can provide an alternative means of accessing the core networks and, in some instances, improved services from the core networks.

### BRIEF DESCRIPTION OF THE DRAWINGS

FIG. 1 illustrates an example system arrangement with untrusted wireless local area network (WLAN) integration in accordance with some embodiments.

FIG. 2 illustrates an example system arrangement with trusted WLAN integration in accordance with some embodiments.

FIG. 3 illustrates a table of example parameters that can be included in a fifth generation quality of service information (5G_QOS_INFO) notify payload in accordance with some embodiments.

FIG. 4 illustrates an example signaling chart for a registration procedure in accordance with some embodiments.

FIG. 5 illustrates an example system arrangement that can provide end-to-end prioritization for multimedia priority service (MPS) via WLAN in accordance with some embodiments.

FIG. 6 illustrates a table showing example quality of service (QoS) information to differentiated services codepoint (DSCP) value mapping in accordance with some embodiments.

FIG. 7 illustrates a table showing example DSCP to QoS information mapping in accordance with some embodiments.

FIG. 8 illustrates a first portion of a table showing example quality of service class identifier (QCI) to DSCP marking recommendations in accordance with some embodiments.

FIG. 9 illustrates a second portion of the table of FIG. 8 in accordance with some embodiments.

FIG. 10 illustrates a table showing example DSCP to WLAN protocol mapping in accordance with some embodiments.

FIG. 11 illustrates a first portion of an example signaling chart for a device centric QoS management approach in accordance with some embodiments.

FIG. 12 illustrates a second portion of the example signaling chart of FIG. 11 in accordance with some embodiments.

FIG. 13 illustrates a first portion of an example signaling chart for a network centric QoS management approach in accordance with some embodiments.

FIG. 14 illustrates a second portion of the example signaling chart of FIG. 13 in accordance with some embodiments.

FIG. 15 illustrates an example procedure to be performed by a user equipment (UE) in accordance with some embodiments.

FIG. 16 illustrates an example procedure to be performed by a network structure in accordance with some embodiments.

FIG. 17 illustrates an example procedure to be performed by a UE in accordance with some embodiments.

FIG. 18 illustrates an example UE in accordance with some embodiments.

FIG. 19 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

There is a need to support multimedia priority service (MPS) communications when the access to the evolved packet core (EPC)/fifth generation core (5GC) is wireless local area network (WLAN). For example, user equipments (UEs) may be capable of accessing EPCs and/or 5GCs. It can be beneficial to support MPS for UEs that in accessing the EPCs and/or the 5GCs. The UEs with MPE prioritization may have services (including transmissions and/or signals related to the service) prioritized over other UEs without MPE prioritization. Accordingly, if service becomes limited for some reason (such as in disaster scenarios) the network that includes the EPC and/or the 5GC may prioritize the services of the UEs with MPE prioritization to ensure, and/or increase the chance, that the services are provided to the UEs with MPE prioritization. In some instances, the services prioritized for UEs with MPE prioritization may be limited to certain services, such as multimedia services, voice services, video call services, and/or data transport sessions, and/or any communications initiated by the UEs.

Support of MPS when the UE has WLAN access may be important during disaster scenarios, such as when third generation partnership project (3GPP) access networks (long-term evolution (LTE) and new radio (NR)) are unavailable or degraded. In some cases, WLAN may be the only available access (e.g., inside buildings, hotels, airports, malls, and stadiums) and, therefore, may be critical for MPS communications. For example, it may be beneficial for disaster scenarios to provide prioritized service to UEs with MPS prioritization. Providing the priority to the UEs with MPS prioritization during the disaster scenarios can ensure that the UEs with MPS prioritization are provided service during the disaster scenarios.

3GPP is enabling support of MPS for multimedia telephony (MMTEL) voice/video calls and to support MPS for Data Transport Service sessions when access is via trusted or untrusted WLAN to the EPC/5GC. For example, it has been proposed to provide support of MPS via WLAN to EPCs and/or 5GCs. The MPS can be applied to voice and/or video call services, and/or data transport service sessions. In some embodiments, MPS can be supported for other services for UEs including multimedia services, voice services, video call services, and/or data transport services.

A new Work Item was agreed in core network and terminals (CT) working groups (WGs) C1-234365 with certain objectives. A first objective may be to provide an indication of MPS authorization from the UE to the trusted WLAN access network (TWAN), evolved packet data gateway (ePDG), and non-3GPP interworking function (N3IWF) for prioritized handling of the UE. A second objective may be to support transport level (e.g., differentiated services codepoint (DSCP)) MPS priority for signaling, for MPS for Data Transport Service (DTS) sessions and MPS MMTEL voice/video sessions. A third objective may be to support congestion control and retry timer exemptions for 3GPP core network access via non-3GPP access networks, as applicable, for MPS subscribed UEs attached via WLAN.

### WLAN Integration in Fifth Generation System (5GS)

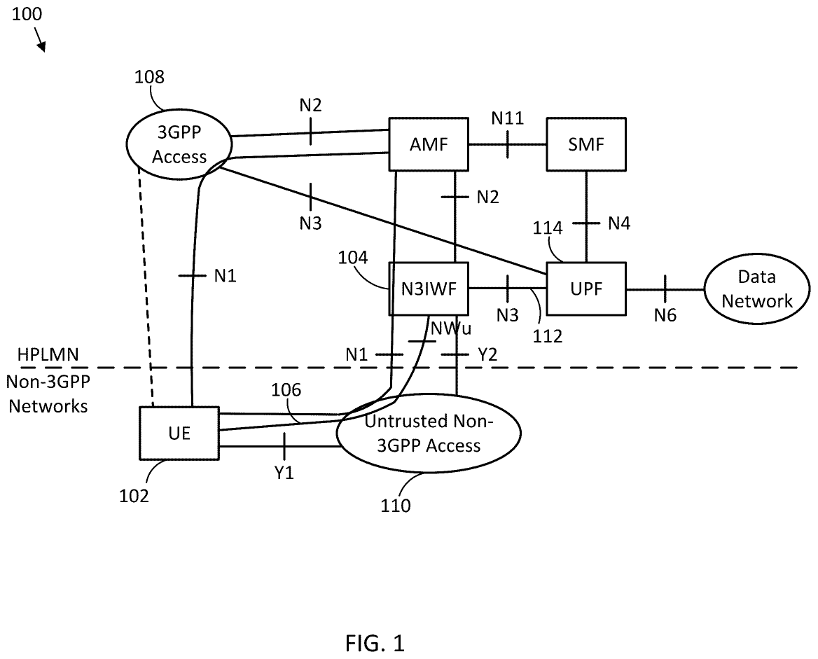

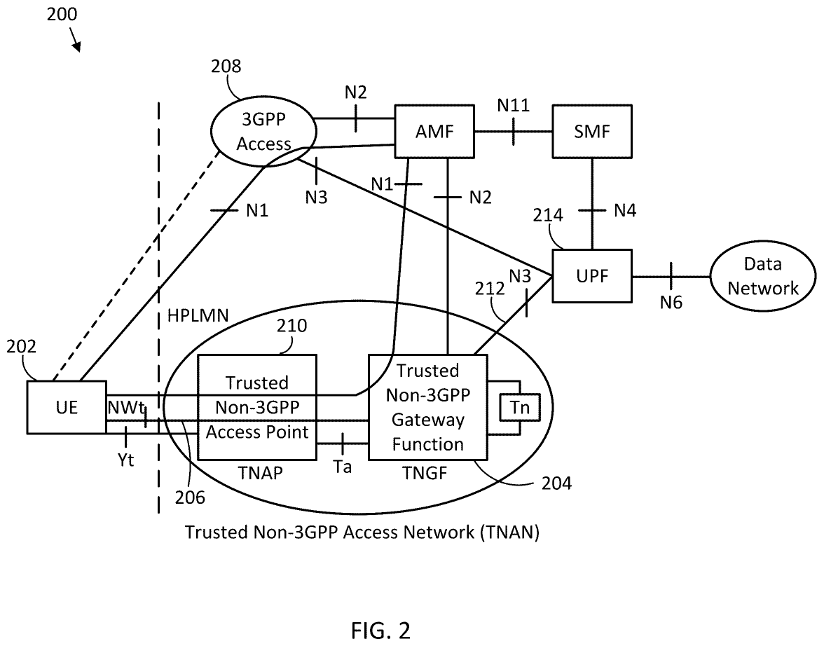

3GPP defines support for integrating Untrusted and Trusted WLAN networks with 5GS through N3IWF and trusted non-3GPP gateway function (TNGF), respectively. For example, some 5GSs may allow UEs to connect to a core network of the 5GS through an N3IWF and/or a TNGF. FIG. 1 illustrates an example system arrangement 100 with untrusted WLAN integration in accordance with some embodiments. FIG. 2 illustrates an example system arrangement 200 with trusted WLAN integration in accordance with some embodiments. It should be understood that the features of the system arrangement 100 and the system arrangement 200 may be implemented by a single system in some examples, where the system may provide both untrusted WLAN integration and trusted WLAN integration.

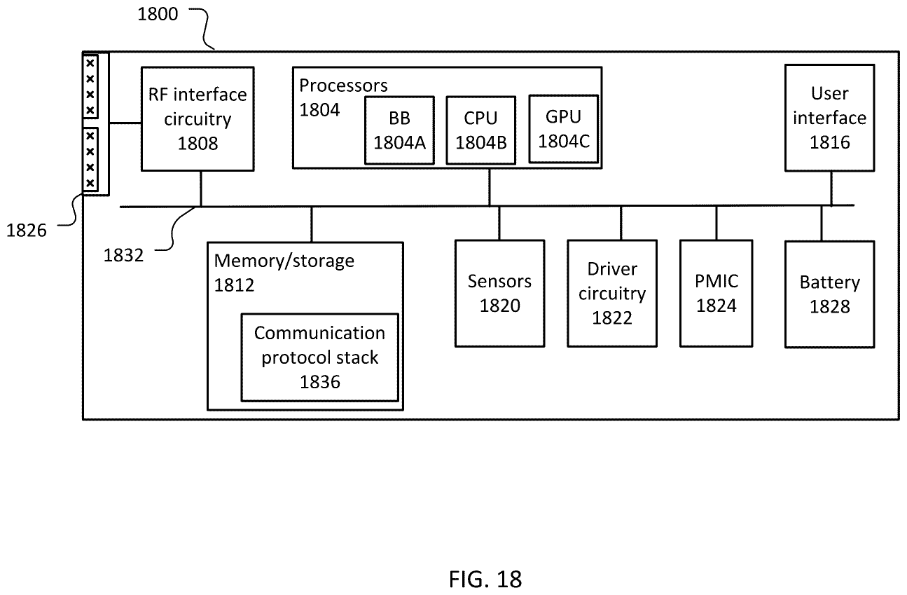

For the integration of untrusted and trusted WLAN networks, transport of non-access stratum (NAS) signaling and user plane data may be done over internet protocol security (IPsec) tunnels established over WLAN—NWu between N3IWF and UE, and/or over NWt between TNGF and UE. For example, the system arrangement 100 may include a UE 102 and an N3IWF 104. The UE 102 may include one or more of the features of the UE 1800 (FIG. 18). The UE 102 may be part of a non-3GPP network and the NW3IWF 104 may be part of a home public land mobile network (HPLMN). An NWu interface 106 may extend between the UE 102 and the N3IWF 104. One or more IPsec tunnels may be established over the NWu interface 106 between the UE 102 and the N3IWF 104 to be utilized for transport of NAS signaling and/or user plane data.

The system arrangement 200 may include a UE 202 and a TNGF 204. The UE 202 may include one or more of the features of the UE 1800 (FIG. 18). The TNGF 204 may be part of a HPLMN, whereas the UE 202 may be outside of the HPLMN. An NWt interface 206 may extend between the UE 202 and the TNGF 204. One or more IPsec tunnels may be established over the NWt interface 206 between the UE 202 and the TNGF 204 to be utilized for transport of NAS signaling and/or user plane data.

A signaling IPsec security association (SA) is established over WLAN to carry NAS messaging. For example, a signaling IPsec SA may be established for carrying NAS messaging via the NWu interface 106 and/or the NWt interface 206. One or more IPsec child SAs are established over WLAN to carry user plane traffic. For example, one or more IPsec child Sas may be established to carry user plane traffic via the NWu interface 106 and/or the NWt interface 206.

N3IWF or TNGF can decide to associate one or more fifth generation (5G) quality of service (QoS) flows for packet data unit (PDU) session with an IPsec child SA. Mapping of 5G QoS flows to IPsec child SA may be left to implementation. QoS flows may be assigned after creation of IP Sec Child SA. 5G QoS model over 3GPP access may also be followed over non-3GPP access. QoS flow, identified by QoS flow identifier (QFI), may define the finest granularity of QoS differentiation over non-3GPP access as well.

For multi-access (MA) PDU session, a QoS flow may be access agnostic and the same QoS may be supported for the flow when traffic is distributed over 3GPP access and/or non-3GPP access. Both guaranteed bit rate (GBR) QoS flows and non-GBR QoS flows can be carried over non-3GPP access. A 5G QoS flow may have the following associated information.

For example, a 5G QoS flow may have a QoS Profile. The QoS profile may specify 5G QoS parameters and QoS characteristics for the flow. The QoS profile may be provided to the 3GPP access and/or N3IWF/TNGF. For example, the QoS profile may be provided to an 3GPP access point 108 of the system arrangement 100, a 3GPP access point 208 of the system arrangement 200, the N3IWF 104, and/or the TNGF 204. For a non-GBR flow, the QoS profile may be sent to both 3GPP and non-3GPP access, if UE is registered over both accesses. For example, the QoS profile may be provided to the 3GPP access point 108 and an untrusted non-3GPP access point 110 of the system arrangement 100, and/or to the 3GPP access point 208 and a trusted non-3GPP access point 210 of the system arrangement 200 for a non-GBR flow when the UE is registered for both 3GPP access and non-3GPP access. For a GBR flow, QoS profile may be sent to only one access based on policy and charging control (PCC) rules. For example, the QoS profile may be provided to the 3GPP access point 108 or the untrusted non-3GPP access point 110 of the system arrangement 100, and/or to the 3GPP access point 208 or the trusted non-3GPP access point 210 of the system arrangement 200 for the GBR flow based on the PCC rules. No traffic splitting may be supported for a GBR flow.

A 5G QoS flow may have one or more QoS Rules. These rules may specify packet filters to map uplink (UL) traffic to QoS flows within a PDU session. QoS rules may either be explicitly signaled to UE, derived by the UE by applying Reflective QoS control, or pre-configured in the UE. For example, the QoS rules may be explicitly signaled to the UE 102 and/or the UE 202, derived by the UE 102 and/or the UE 202 via application of reflective QoS control, or preconfigured in the UE 102 and/or the UE 202.

A 5G QoS flow may have QoS Flow Descriptions. The QoS flow descriptions may be optional. The QoS flow descriptions may specify QoS parameters for the flow. The QoS flow descriptions may be sent to UE to provide QoS differentiation for the flow. For example, the QoS flow descriptions may be sent to the UE 102 and/or the UE 202.

A 5G QoS flow may have one or more Packet Detection Rules (PDRs). These rules may specify packet filters to map incoming packets at the user plane function (UPF) to N3/N9 tunnel established with the N3IWF/TNGF. For example, the system arrangement 100 may have an N3 tunnel 112 established between the N3IWF 104 and a UPF 114 of the system arrangement 100. The system arrangement 200 may have an N3 tunnel 212 established between the TNGF 204 and a UPF 214 of the system arrangement 200. The PDRs may specify packet filters for mapping incoming packets to the N3 tunnel 112 and/or the N3 tunnel 212. The PDRs may include Multi-Access Rule (MAR) for MA PDU session which indicates access traffic steering, switching, and splitting (ATSSS) steering mode and steering functionality.

### QoS Signaling at N3IWF/TNGF for WLAN

During the PDU session establishment, the N3IWF/TNGF may determine the number of user plane IPsec child SAs to establish with the UE and QoS profile(s) associated with each child SA. For example, the N3IWF 104 may determine the number of user plane IPsec child SAs to establish with the UE 102 and/or the TNGF 204 may determine the number of user plane IPsec child SAs to establish with the UE 202. One IPsec child SA can be associated with one or more QoS flows of the PDU session.

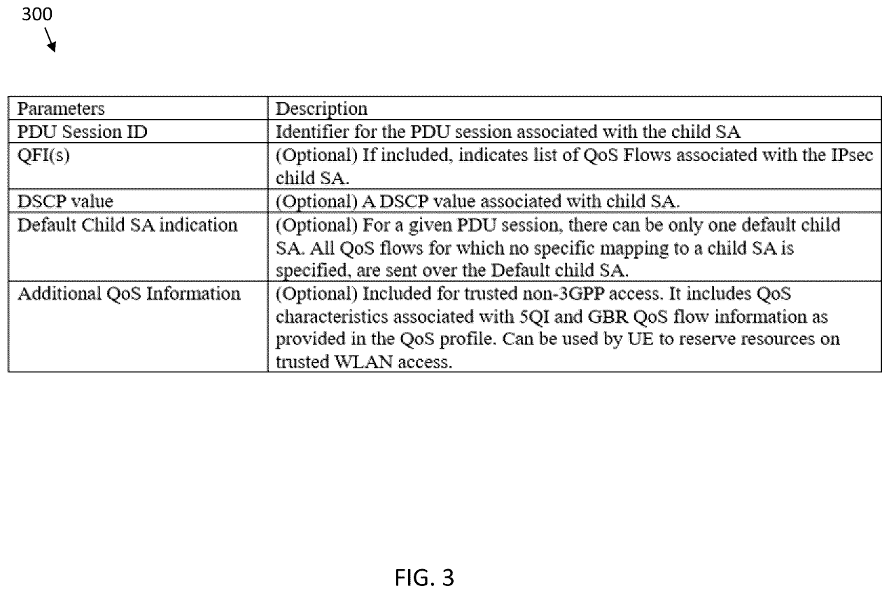

An internet key exchange (IKE) Create_Child_SA request may be sent to the UE to establish a child SA and it may include a 5G_QOS_INFO Notify payload specifying QoS specific parameters. For example, an IKE Create_Child_SA request may be sent to the UE 102 and/or the UE 202 to establish a child SA. The IKE Create_Child_SA request may include a 5G_QOS_INFO notify payload. FIG. 3 illustrates a table 300 of example parameters that can be included in a 5G_QOS_INFO notify payload in accordance with some embodiments. In particular, the IKE Create_Child_SA request sent to the UE may include a 5G_QOS_INFO notify payload that may have one or more of the parameters illustrated by the table 300.

N3IWF or TNGF can associate a DSCP value with an IPsec child SA, in an implementation specific way. For example, the N3IWF 104 (FIG. 1) and/or the TNGF 204 (FIG. 2) may associate a DSCP value with an IPsec child SA. The UE and the N3IWF/TNGF may mark all internet protocol (IP) packets sent over a child SA with the associated DSCP value (if any). For example, the UE 102 (FIG. 1), the UE 202 (FIG. 2), the N3IWF 104, and/or the TNGF 204 may mark IP packets sent over a child SA with an associated DSCP value.

If multiple QoS flows are aggregated into the same IPsec child SA, the TNGF may derive the QoS Characteristics and/or the GBR QoS Flow Information of the aggregated flow based on QoS profile for individual flows. For example, the TNGF 204 may derive QoS characteristics and/or GBR QoS flow information if multiple QoS flows are aggregated into the same IPsec child SA, where the QoS characteristics and/or the GBR QoS flow information of the aggregated flow may be derived based on QoS profiles for the individual flows.

### Multimedia Priority Service (MPS) Over 3GPP Access in Evolved Packet System (EPS)/5GS

MPS support for 3GPP access may be available in EPS/5GS and internet protocol multimedia subsystem (IMS) core network (CN) as follows. UE with MPS subscription may send a priority radio resource control (RRC) Establishment Cause based on MPS subscription information stored in the universal subscriber identity module (USIM) during the Attach/initial Registration procedure. Upon receipt, the evolved NodeB (eNB)/radio access network (RAN) and mobility management entity (MME)/access and mobility management function (AMF) can treat the UE with priority.

The MME/AMF may receive the MPS subscription information from the home subscriber service (HSS)/unified data management (UDM) for MPS subscribed UE during the Attach/initial Registration procedure. User plane resources under the control of the 3GPP system may be provided priority based on (HSS/UDM) subscription-based MPS-specific QoS parameters assigned to the default bearer(s)/QoS flow(s) carrying MPS traffic, or the MPS-specific QoS parameters selected by the policy and charging rules function (PCRF)/policy control function (PCF) and provided to the EPC/5GC.

Characteristics for MPS over WLAN

Updates to support MPS over WLAN in EPS/5GS may include the following. For example, UE with MPS subscription may indicate its MPS capability during Attach/initial Registration procedure. This enables the TWAN/trusted non-3GPP access network (TNAN) (for example, Trusted WLAN) and the ePDG/N3IWF (for example, Untrusted WLAN) to treat an MPS subscribed UE with priority based on operator policy, either during authentication, or after the network has successfully authenticated the UE. Further, updates to allow the 3GPP network to send the UE's MPS subscription information (from HSS/UDM) to the Trusted WLAN, the Untrusted WLAN, and the ePDG/N3IWF may support MPS over WLAN in EPS and/or 5GS.

Additionally, updates to communicate 3GPP capabilities of per packet data network (PDN) connection/PDU session, and per bearer/QoS flow QoS treatment to WLAN may support MPS over WLAN in EPS and/or 5GS. This may include QoS treatment for the media associated with all authorized MPS sessions (for example, regardless of the UE subscription for MPS). DSCP may be the mechanism of QoS differentiation by which a WLAN may apply any WLAN QoS mechanism. Application of DSCP between the UE, the WLAN, and the 3GPP network may also be implemented.

### Approach for MPS Over WLAN—General Concepts

Updates to N3IWF may include the following. MPS subscription may allow users to receive priority services if the network supports MPS. The same MPS subscription may apply to access via 3GPP access and non-3GPP access via WLAN. MPS may be supported for Service Users using UEs that support connecting via trusted or untrusted non-3GPP access via WLAN.

For WLAN access, the UE may notify the TNAN/N3IWF of its MPS subscription before the NAS Registration Request. Based on operator policy, the TNAN/N3IWF may use this indication to provide this UE with priority treatment in the case of congestion/overload before receipt of the NAS Registration Request with an MPS priority establishment cause.

A further update to N3IWF may include enforcing QoS corresponding to N3 packet marking (e.g., DSCP), taking into account QoS requirements associated to such marking received over N2. QoS may include 5G QoS identifier (5QI), the Priority Level (if explicitly signaled) and optionally, the allocation and retention priority (ARP) priority level. Based on operator policy and/or regional/national regulations, the N3IWF can apply a different DSCP value to the outer encapsulating security payload (ESP) tunnel packet than the DSCP value of the inner IP packet.

Another update may include packet marking in the downlink, and the uplink on N2 and N3, e.g., setting the DSCP value based on the Establishment cause on N2, and based on 5QI, the Priority Level (if explicitly signaled) and optionally, the ARP priority level on N3.

Other Updates may include the following. For example, UE may be made aware of WLAN MPS capability like shared in Registration Accept in 3GPP to know if it can use MPS in next access. Like configuration update command (CUC) in 3GPP, there is no mechanism to update MPS in WLAN dynamically (Notification). Further, Authentication and Authorization may be updated, such as if Authentication/Authorization fails specific to MPS, there may be an explicit indication back to UE. MPS priority may be shared with N3IWF from UDM/authentication service function (AUSF).

### Approach for MPS Over WLAN—Registration Procedure

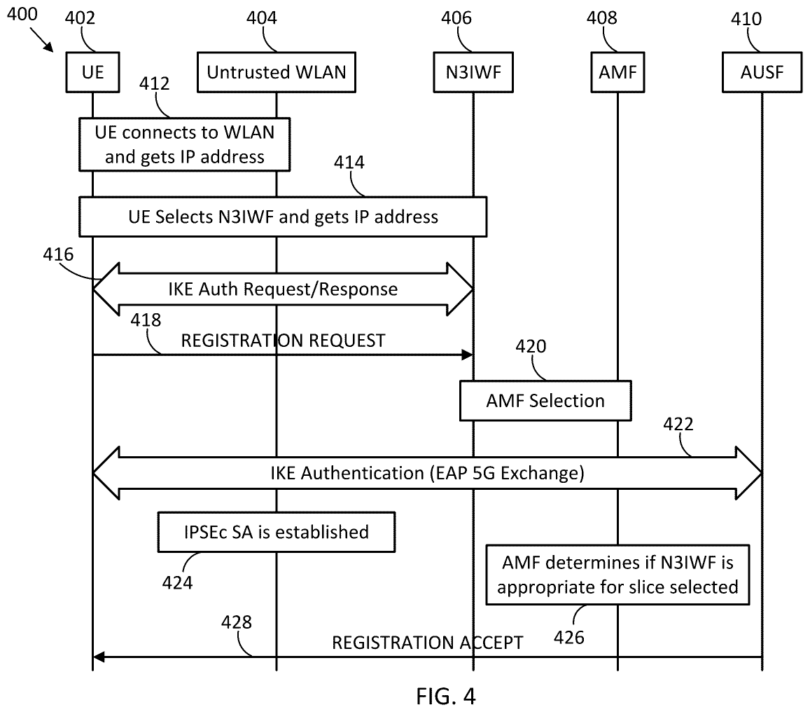

FIG. 4 illustrates an example signaling chart 400 for a registration procedure in accordance with some embodiments. For example, the registration procedure may be performed as part of a UE (such as the UE 102 (FIG. 1) and/or the UE 202 (FIG. 1)) registering with an EPC and/or 5GC network via WLAN access in accordance with some embodiments. The signaling chart 400 illustrates operations and/or signals that may be exchanged between elements of the EPC and/or the 5GC network as part of the registration procedure.

The signaling chart 400 may include a UE 402. The UE 402 may include one or more of the features of the UE 102 (FIG. 1), the UE 202 (FIG. 2), and/or the UE 1800 (FIG. 18). The registration procedure illustrated by the signaling chart 400 may be performed to register the UE 402 with an EPC and/or 5GC network via WLAN access.

The signaling chart 400 may include an untrusted WLAN access point 404. The untrusted WLAN access point 404 may include one or more of the features of the untrusted non-3GPP access point 110 (FIG. 1). The untrusted WLAN access point 404 may not be controlled by a same operator as the operator of the EPC and/or the 5GC network. The untrusted WLAN access point 404 may provide access to the EPC and/or the 5GC network via WLAN. As the untrusted WLAN access point 404 is untrusted by the EPC and/or the 5GC network, the untrusted WLAN access point 404 may be located outside of a HPLMN that includes the EPC and/or the 5GC network, and may have higher security standards for accessing the EPC and/or the 5GC network than trusted WLAN access points.

The signaling chart 400 may include an N3IWF 406. The N3IWF 406 may include one or more of the features of the N3IWF 104 (FIG. 1). The N3IWF 406 may act as a gateway for the EPC and/or the 5GC network, and may provide an N3 interface (such as the N3 tunnel 112 (FIG. 1) and an N2 interface within the EPC and/or the 5GC network. The N3IWF 406 may facilitate authentication and/or registration of UEs connecting to the EPC and/or the 5GC network via the untrusted WLAN access point 404. Further, services from the EPC and/or 5GC network may be provided to the UE connected via the untrusted WLAN access point 404 through the N3IWF 406.

In other embodiments, the UE 402 may connect to the EPC and/or the 5GC network through a trusted WLAN access point (such as the trusted non-3GPP access point 210 (FIG. 2)). In these embodiments, the untrusted WLAN access point 404 may be replaced by a trusted WLAN access point. The trusted WLAN access point may be controlled by a same operator as the operator of the EPC and/or the 5GC network. The trusted WLAN access point may be located within the HPLMN and may provide one or more of the services of the untrusted WLAN access point 404 to the UE. The trusted WLAN access point may perform one or more of the operations, and/or receive one or more of the signals/messages, described as being implemented by the untrusted WLAN access point 404.

Further, the N3IWF 406 may be replaced by a TNGF (such as the TNGF 204 (FIG. 2)) in embodiments where the UE connects to the EPC and/or the 5GC network through the trusted WLAN access point. The TNGF may act as a gateway for the EPC and/or the 5GC network, and may provide an N3 interface (such as the N3 tunnel 212 (FIG. 2)) and an N2 interface for the EPC and/or the 5GC network. The TNGF may perform one or more of the operations, and/or receive one or more of the signals/messages, described as being implemented by the N3IWF 406.

The signaling chart 400 may include an AMF 408. The AMF 408 may be a control plane function that can provide one or more services, such as registration management reachability management, connection management, and/or mobility management. The AMF 408 may facilitate registration of UEs with the EPC and/or 5GC network.

The signaling chart 400 may include an AUSF 410. The AUSF 410 may facilitate authentication of UEs connecting to the EPC and/or the 5GC network.

The UE 402 may connect to the untrusted WLAN access point 404 in 412. For example, the UE 402 may establish a connection with the untrusted WLAN access point 404 through exchange of signals. The UE 402 may get an IP address from the untrusted WLAN access point 404 that the UE 402 may utilize to exchange signals with the untrusted WLAN access point 404.

When the UE decides to attach to 5GC network, selects an N3IWF in a 5G public land mobile network (PLMN). For example, the UE 402 may determine that the UE 402 is to attach to the EPC and/or the 5GC network for services. Based on the UE 402 determining that the UE 402 is to attach to the EPC and/or the 5GC network, the UE 402 may select an N3IWF to which to connect in 414. The N3IWF to which the UE 402 selects to connect may be predefined, may be based on characteristics of the UE 402, and/or may be based on the services for which the UE 402 is attaching to the EPC and/or the 5GC network. In the illustrated embodiment, the UE 402 may select to attach to the N3IWF 406. The UE 402 may get an IP address from the N3IWF 406 that the UE 402 may utilize to exchange signals with the N3IWF 406.

UE may proceed with the establishment of an IPsec Security Association (SA) with the selected N3IWF by initiating an IKE initial exchange according to RFC 7296. For example, the UE 402 may initiate an IKE exchange in 416. UE may initiate an IKE_AUTH exchange by sending an IKE_AUTH request message. For example, the UE 402 may transmit an IKE authentication (IKE_AUTH) request message to the N3IWF 406 as part of the IKE exchange in 416. If the UE has an MPS subscription, the UE may include a Notify payload in the IKE_AUTH request indicating its MPS subscription. For example, the UE 402 may include an indication that the UE 402 has MPS prioritization in the IKE_AUTH request message. In some embodiments, the UE 402 may have the MPS prioritization based on the UE 402 subscribing to an MPS. The UE 402 may include the indication that the UE 402 has MPS prioritization in a notify payload of the IKE_AUTH request message.

The N3IWF may respond with an IKE_AUTH response message, which may include an EAP-Request/5G-Start packet. For example, the N3IWF 406 may provide an IKE_AUTH response message to the UE 402. The IKE_AUTH response message may be provided in response to the IKE_AUTH request message. The IKE_AUTH response message may include an extensible authentication protocol request (EAP-Request)/5G-Start packet. The EAP-Request/5G-Start packet may inform the UE to initiate an EAP-5G session, for example, to start sending NAS messages encapsulated within EAP-5G packets.

In the case of trusted WLAN access, if the UE has an MPS subscription, the UE may also include an indication of its MPS subscription in the username part of a network access identifier (NAI). For example, the UE 402 may provide an NAI to the N3IWF 406 as part of 416. In embodiments where the UE 402 is utilizing a trusted WLAN access point to access the EPC/5GC network, the UE 402 may include an indication that the UE 402 has MPS prioritization within a username part of the NAI. Based on operator policy, after receiving the indication of MPS subscription from the UE, the TNAN can treat this UE with priority. For example, the trusted WLAN access point and the TNGF may be part of a TNAN. After the WLAN access point receives the indication of the UE having MPS prioritization, the TNAN may treat the UE with priority (such as prioritizing signals related to the UE) based on operator policy.

The UE may send an IKE_AUTH request, which includes an EAP-Response/5G-NAS packet that contains the Access Network (AN) parameters (AN parameters) and a Registration Request message. For example, the UE 402 may send a registration request message to the N3IWF 406 in 418. The registration request message may be included in an EAP-Response/5G-NAS packet, where the EAP-Response/5G-NAS packet may include AN parameters and the registration request message. In some embodiments, the EAP-Response/5G-NAS packet may be included in an IKE_AUTH request (such as the IKE_AUTH request message).

The AN parameters may contain information that is used by the N3IWF for selecting an AMF in the 5GC. This information may include, for example, the globally unique AMF identifier (GUAMI), the Selected PLMN ID, the Requested NSSAI, and/or the Establishment cause related to the UE 402. The Establishment cause may provide the reason for requesting a signaling connection with the EPC and/or the 5GC, and the N3IWF may use the Establishment cause to determine the DSCP value on N2. For example, the N3IWF 406 may receive the AN parameters from the UE 402. The N3IWF 406 may identify an indication of the establishment cause from the AN parameters and determine a DSCP value to be utilized for an N2 interface of the EPC and/or the 5GC network.

The N3IWF may select an AMF based on the received AN parameters and local policy and forwards Registration Request message to selected AMF. For example, the N3IWF 406 may select an AMF based on the AN parameters received from the UE 402 and/or a local policy related to the N3IWF 406 in 420. In the illustrated embodiment, the N3IWF 406 may select the AMF 408 based on the AN parameters and/or the local policy. The N3IWF 406 may provide the registration request received from the UE 402 in 418 to the AMF 408.

The selected AMF may decide to request the subscription concealed identifier (SUCI) by sending a NAS Identity Request message to UE. For example, the AMF 408 may send a NAS identity request message to the UE 402 as part of 422. The NAS identity request message may include and/or indicate a request for a SUCI. The AMF may use the Establishment cause to determine the Message Priority header and then the DSCP value for subsequent signaling. For example, the AMF 408 may utilize the establishment cause received from the UE 402 to determine a message priority header and/or a DSCP value for subsequent signaling related to the UE 402.

The AMF may decide to authenticate the UE by invoking an authentication server function (AUSF). In this case, the AMF may select an AUSF based on subscription permanent identifier (SUPI) or SUCI. For example, the AMF 408 may determine that the UE 402 is to be authenticated. The AMF 408 may select the AUSF 410 for the authentication based on a SUPI or the SUCI associated with the UE 402. The AMF 408 may invoke the AUSF 410 to authenticate the UE 402. The AUSF 410 may execute the authentication of the UE as specified in technical specification (TS) 33.501 (3^{rd} Generation Partnership Project; Technical Specification Group Services and System Aspects; Security architecture and procedures for 5G system (Release 18). (2023). 3GPP TS 33.501, 18.2.0). The AUSF may selects a UDM and may get the authentication data from UDM. For example, the AUSF 410 may select a UDM and may retrieve authentication data from the selected UDF.

The AMF 408 may send a NAS Security Mode Command to UE 402 in order to activate NAS security. The UE 402 may complete the improved extensible authentication protocol method for 3^{rd} generation authentication and key agreement (EAP-AKA′) authentication, create a NAS security context, and/or send the NAS Security Mode Complete message which is relayed by the N3IWF 406 to the AMF 408. Upon receiving the NAS Security Mode Complete, the AMF 408 may send an NGAP Initial Context Setup Request message that includes the N3IWF key. This may trigger the N3IWF 406 to send an EAP-Success to the UE 402, which completes the EAP-5G session.

The IPsec SA may be established between the UE 402 and N3IWF 406 in 424. For example, an IPsec SA may be established between the UE 402 and the N3IWF 406. The N3IWF 406 may apply a DSCP value to this signaling IPsec SA, in which case all IP packets exchanged between the UE 402 and N3IWF 406 via the “signaling IPsec SA” may be marked with this DSCP value. The DSCP value may be determined by operator policy, and may, for example, be based on the DSCP value on N2.

The AMF 408 may determine the subset of the requested network slice selection assistance information (NSSAI) that is allowed by the subscribed single network slice selection assistance information (S-NSSAI) or S-NSSAI(s) in 426. A slice may be selected based on the subset of the requested NSSAI. The AMF 408 may determine whether the N3IWF 406 is appropriate for the slice selected.

The AMF 408 may send the NAS Registration Accept message in an N2 message sent to the N3IWF in 428. For example, the AMF 408 may send an N2 message to the N3IWF 428 via an N2 interface between the AMF 408 and the N3IWF 428. The N2 message may include the NAS registration accept message. The N2 Message may include the Allowed NSSAI for the access type for the UE 402. The Allowed NSSAI may be a subset of the slices supported by the selected N3IWF 406. The N3IWF 406 may forward the NAS Registration Accept message to UE 402 via the established signaling IPsec SA.

### Approach for MPS Over WLAN—1: DSCP Signaling Based E2E QoS Model

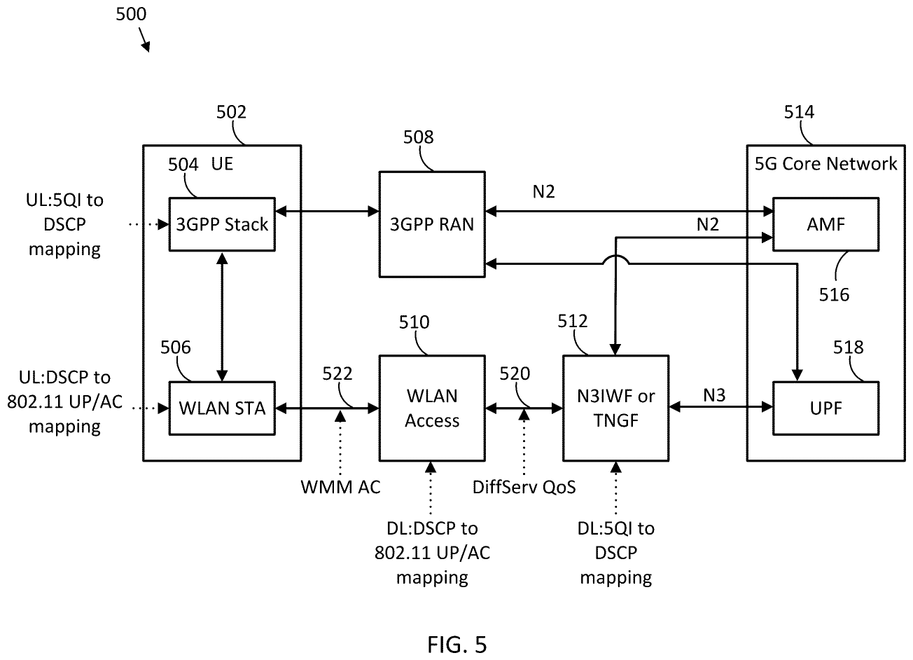

For end-to-end QoS over 5G and WLAN, it may be beneficial to achieve QoS differentiation across all network segments. FIG. 5 illustrates an example system arrangement 500 that can provide end-to-end prioritization for MPS via WLAN in accordance with some embodiments.

The system arrangement 500 may implement in-band DSCP signaling. For in-band DSCP signaling, 5G QoS can be mapped to DSCP marking which gets mapped to WLAN user plane (UP)/access category (AC) within WLAN domain. For example, elements of the system arrangement 500 may map QoS flow to DSCP markings. In turn, the DSCP markings may map signals with the DSCP markings to corresponding WLAN UP/AC within the WLAN domain.

The system arrangement 500 may include a UE 502. The UE 502 may include one or more of the features of the UE 102 (FIG. 1), the UE 202 (FIG. 2), the UE 402 (FIG. 4), and/or the UE 1800 (FIG. 18). The UE 502 may include a 3GPP stack 504 and a WLAN station (STA) 506. The 3GPP stack 504 may facilitate communication of the UE 502 with a 3GPP network (such as the EPC and/or the 5GC network). The WLAN STA 506 may facilitate communication of the UE 502 with a WLAN network.

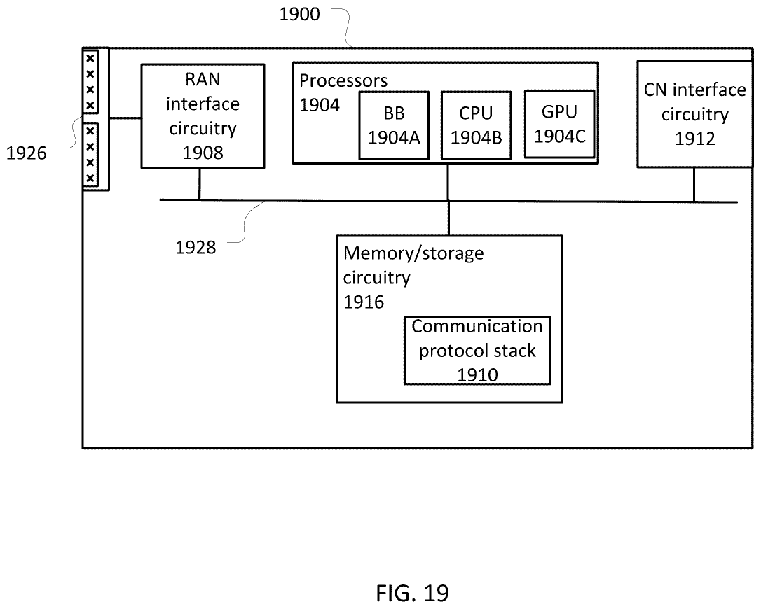

The system arrangement 500 may include a 3GPP RAN node 508. The 3GPP RAN node 508 may provide access to a core network and corresponding services via 3GPP technology. For example, the UE 502 may establish a connection with the 3GPP RAN node 508 via 3GPP technology. The 3GPP RAN node 508 may include a base station, such as a nodeB, an evolved nodeB (eNB), a next generation nodeB (gNB), or some combination thereof. The 3GPP RAN node 508 may include one or more of the features of the 3GPP access point 108 (FIG. 1), the 3GPP access point 208 (FIG. 2), and/or the gNB 1900 (FIG. 19).

The system arrangement 500 may include a WLAN access point 510. The WLAN access point 510 may be an untrusted WLAN access point or a trusted WLAN access point. The WLAN access point 510 may include one or more of the features of the untrusted non-3GPP access point 110 (FIG. 1), the trusted non-3GPP access point 210 (FIG. 2), and/or the untrusted WLAN access point 404 (FIG. 4). The WLAN access point 510 may provide access to a core network and corresponding services via WLAN technology. For example, the UE 502 may establish a connection with the WLAN access point 510 via WLAN technology.

The system arrangement 500 may include a gateway function 512. The gateway function 512 may include an N3IWF or a TNGF. The gateway function 512 may include one or more of the features of the N3IWF 104 (FIG. 1), the TNGF 204 (FIG. 2), and/or the N3IWF 406 (FIG. 4). The WLAN access point 510 may establish a connection with the gateway function 512 to access a core network.

The system arrangement 500 may include a core network 514. The core network 514 may include an EPC and/or a 5GC network. The core network 514 may include an AMF 516 and a UPF 518. The AMF 516 may include one or more of the features of the AMF 408 (FIG. 4). The UPF 518 may include one or more of the features of the UPF 114 (FIG. 1) and/or the UPF 214 (FIG. 2). The 3GPP RAN node 508 and the gateway function 512 may establish connections with the core network 514, or components thereof. For example, the gateway function 512 may have an N2 interface that extends between the gateway function 512 and the AMF 516, and an N3 interface that extends between the gateway function 512 and the UPF 518. The N2 interface and the N3 interface may be dedicated backhaul.

In downlink (DL), the N3IWF/TNGF may map 5QI to DSCP markings. For example, the gateway function 512 may map data and/or signals being promulgated in the DL to DSCP markings corresponding to the 5QI associated with the UE 502. In particular, the gateway function 512 may map data received from the AMF 516 and/or the UPF 518 to the proper DSCP value for the UE 502.

In uplink (UL), the 3GPP stack 504 may map the 5QI to DSCP markings. For example, the 3GPP stack 504 of the UE 502 may map data and/or signal being promulgated in the UL to DSCP markings corresponding to the 5QI associated with the UE 502.

The IP path between N3IWF/TNGF and WLAN access may apply DSCP based prioritization, assuming it is part of a managed network. For example, an IP path 520 may be established between the gateway function 512 and the WLAN access point 510. Signals promulgated via the IP path 520 may be prioritized based on the DSCP values corresponding to the signals. For example, certain DSCP values may be assigned to signals that correspond to UEs that have MPS prioritization. These DSCP values may cause transmission of the signals to be prioritized over other signals associated with DSCP values corresponding to UEs that do not have MPS prioritization.

WLAN AP and STA may map DSCP markings to 802.11 UP/AC as defined in 802.11 specification (also in RFC 8325). For example, the WLAN access point 510 and/or the WLAN STA 506 may map the DSCP markings to a WLAN protocol, such as 802.11 UP/AC. A wireless connection 522 may be established between the WLAN STA 506 and the WLAN access point 510. The mapping of the DSCP markings to the WLAN protocol may cause certain signals corresponding to UEs with MPS prioritization being promulgated by the wireless connection 522 to be prioritized over other signals corresponding to UEs without MPS prioritization. For example, the DSCP markings to WLAN protocol mapping may cause certain DSCP values to be mapped to certain WLAN protocol values that a WiFi multimedia (WMM) AC for the wireless connection 522 prioritizes transmission across the wireless connection 522.

In the illustrated embodiment, the UE 502 may have MPS prioritization. Accordingly, the signals corresponding to the UE 502 may be prioritized by the 5QI to DSCP mapping and the DSCP to WLAN protocol mapping. The signals corresponding to the UE 502 may be prioritized across the wireless connection 522 and the IP path 520 based on the mappings. Therefore, end-to-end (E2E) prioritization for the signals may be provided for the UE 502. This option for E2E QoS assumes that backhaul between N3IWF/TNGF and 5G Core is managed by the mobile network operator (MNO). For example, the N2 interface between the gateway function 512 and the AMF 516, and the N3 interface between the gateway function 512 and the UPF 518 may be managed by an MNO in the illustrated embodiment.

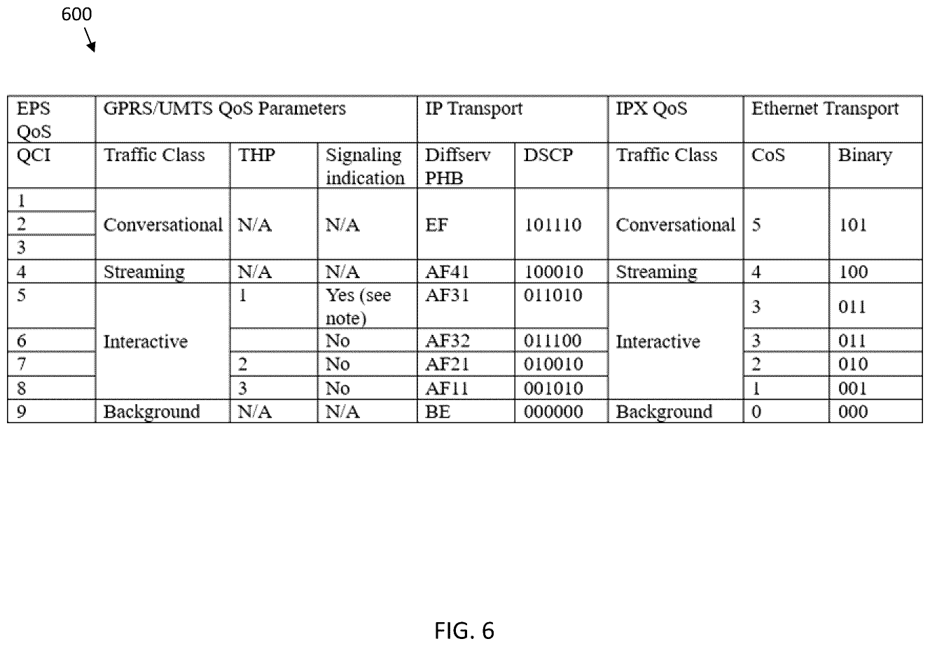

FIG. 6 illustrates a table 600 showing example QoS information to DSCP value mapping in accordance with some embodiments. For example, the table 600 shows second generation (2G)/third generation (3G)/EPS QoS information and corresponding mapping to class of service (CoS) and DSCP values. The table 600 corresponds to Table 3 in Official Document IR.34—Guidelines for IPX Provider networks (Guidelines for IPX Provider networks (Previously Inter-Service Provider IP Backbone Guidelines. (2018-08). GSM Association Official Document IR.34, 14.0). The system arrangement 500 (FIG. 5) may implement the QoS to DSCP value mapping as shown within the table 600, or similar QoS to DSCP value mapping.

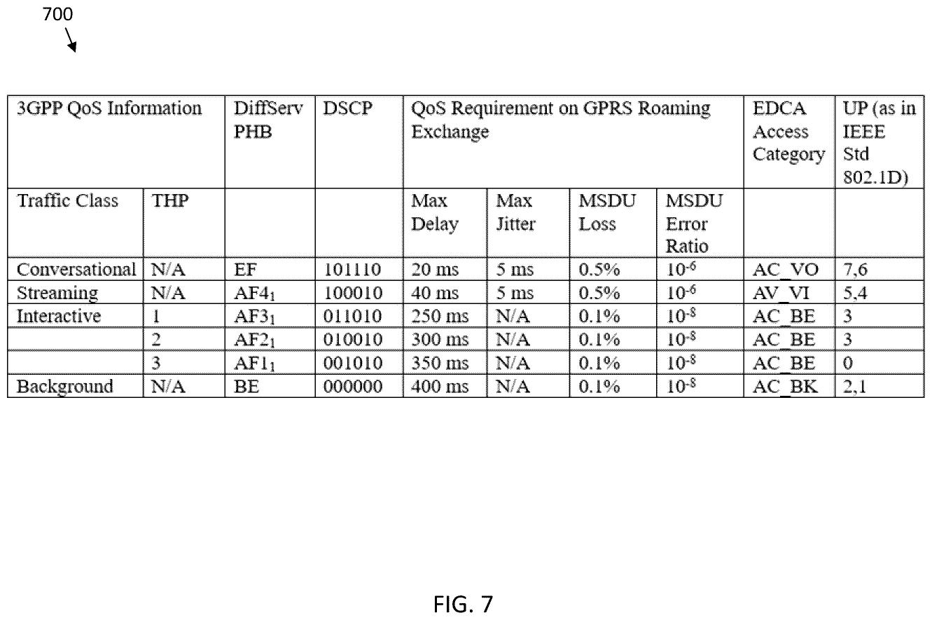

FIG. 7 illustrates a table 700 showing example DSCP to QoS information mapping in accordance with some embodiments. For example, the table 700 shows a mapping table of DSCP to 3GPP QoS information and enhanced distributed channel access (EDCA) ACs. The table 700 corresponds to Table R-1 in IEEE Standard for Information Technology Part 11 (IEEE Standard for Information technology—Telecommunications and information exchange between systems Local and metropolitan area networks—Specific requirements; Part 11: Wireless LAN Medium Access Control (MAC) and Physical Layer (PHY) Specifications. (2016-12). IEEE Std 802.11-2016). The system arrangement 500 (FIG. 5) may implement the DSCP to 3GPP QoS information and EDCA ACs mapping as shown within the table 700, or similar DSCP to 3GPP QoS information and EDCA ACs mapping.

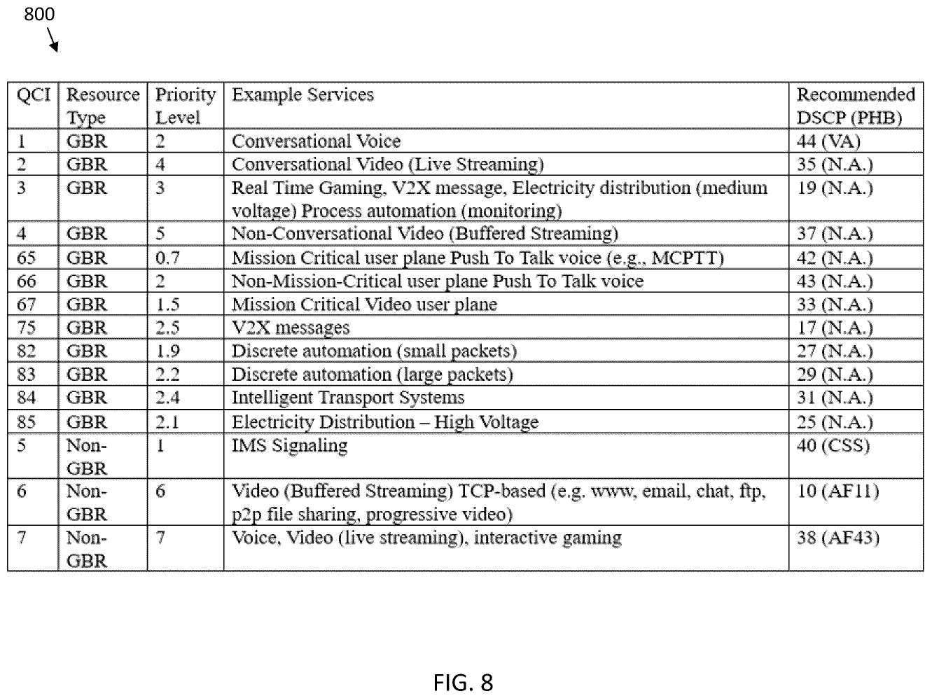

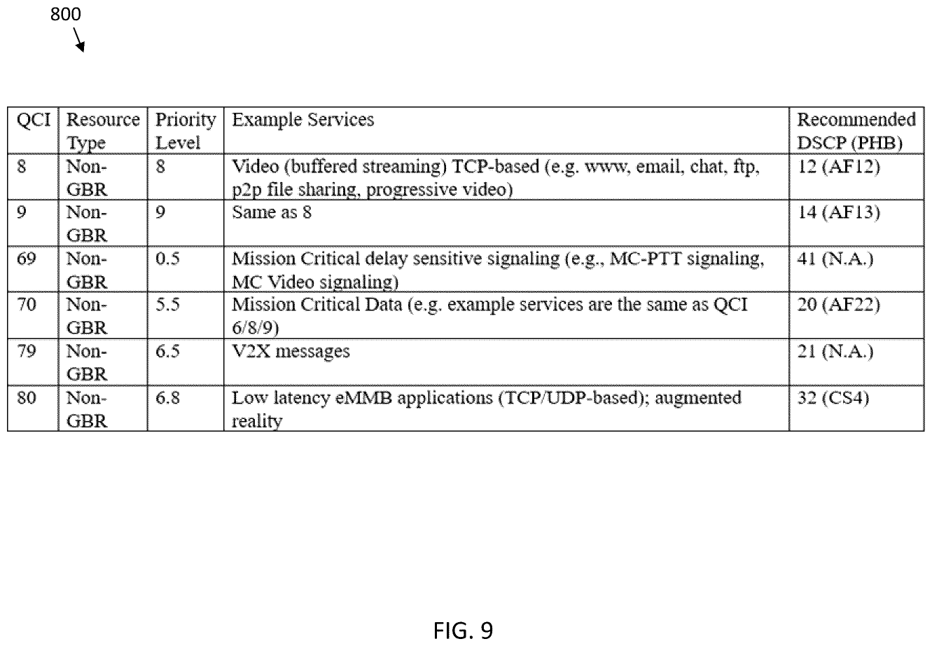

FIG. 8 illustrates a first portion of a table 800 showing example quality of service class identifier (QCI) to DSCP marking recommendations in accordance with some embodiments. FIG. 9 illustrates a second portion of the table 800 of FIG. 8 in accordance with some embodiments. For example, the table 800 shows 3GPP QCI to DSCP marking recommendations. The data shown in the table 800 may be utilized for differentiated services (Diffserv) to QCI mapping. The system arrangement 500 (FIG. 5) may implement the QCI to DSCP marking recommendations shown within the table 800, or similar QCI to DSCP marking recommendations. For example, the system arrangement 500 may implement the QCI to DSCP marking recommendations for transmission of signals across the IP path 520 (FIG. 5).

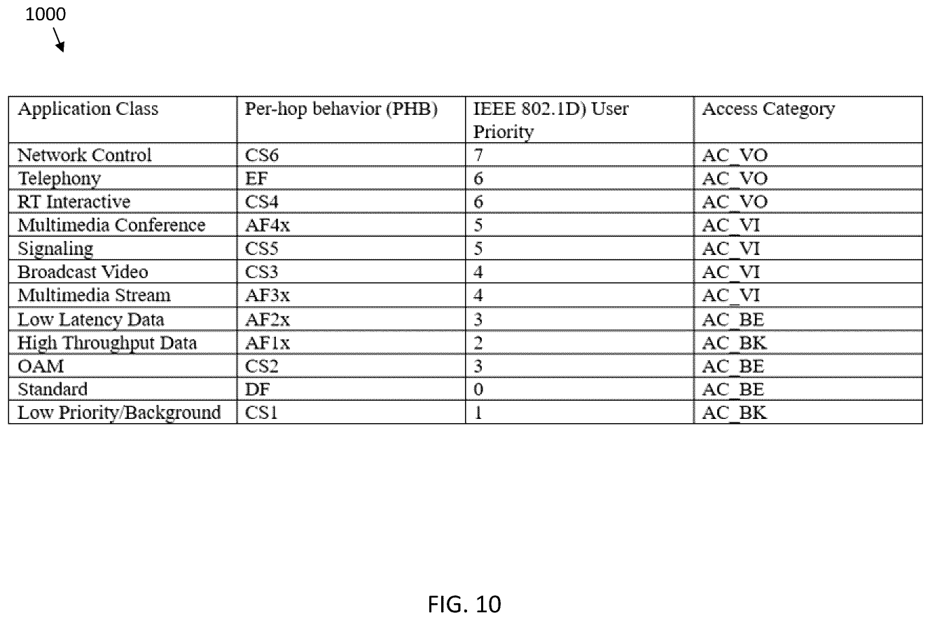

FIG. 10 illustrates a table 1000 showing example DSCP to WLAN protocol mapping in accordance with some embodiments. For example, the table 1000 shows example enterprise DSCP to UP/AC mapping. The table 1000 corresponds to Table R-2 in IEEE Standard for Information Technology Part 11 (IEEE Standard for Information technology—Telecommunications and information exchange between systems Local and metropolitan area networks—Specific requirements; Part 11: Wireless LAN Medium Access Control (MAC) and Physical Layer (PHY) Specifications. (2016-12). IEEE Std 802.11-2016). The system arrangement 500 (FIG. 5) may implement the DSCP to WLAN protocol mapping shown within the table 1000, or similar DSCP to WLAN protocol mapping. For example, the system arrangement 500 may implement the DSCP to WLAN protocol mapping for transmission of signals across the wireless connection 522 (FIG. 5).

### Approach for MPS Over WLAN—2: UE Centric E2E QoS Model

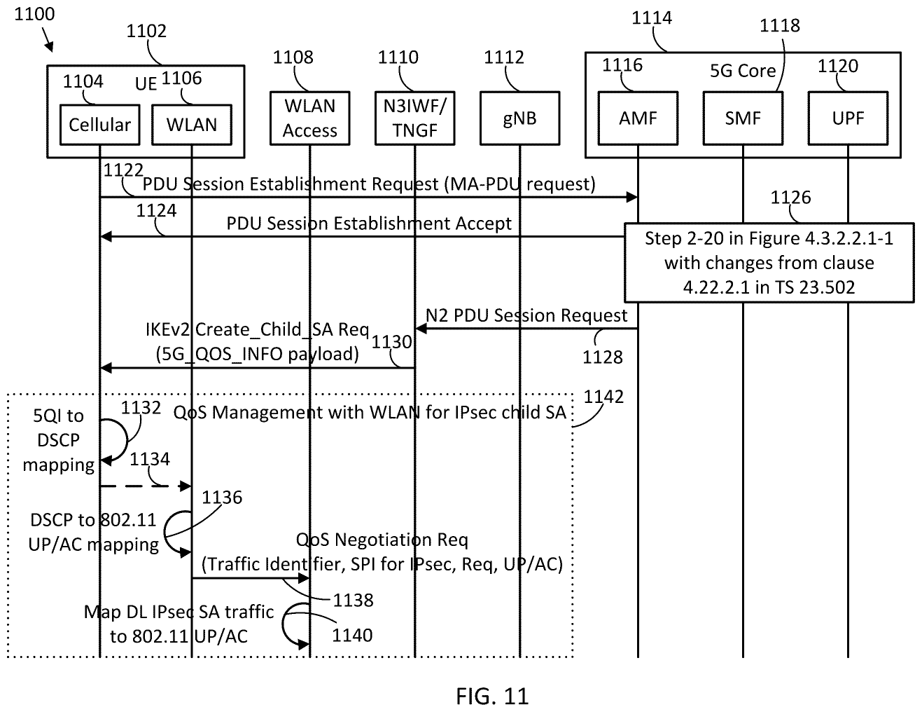

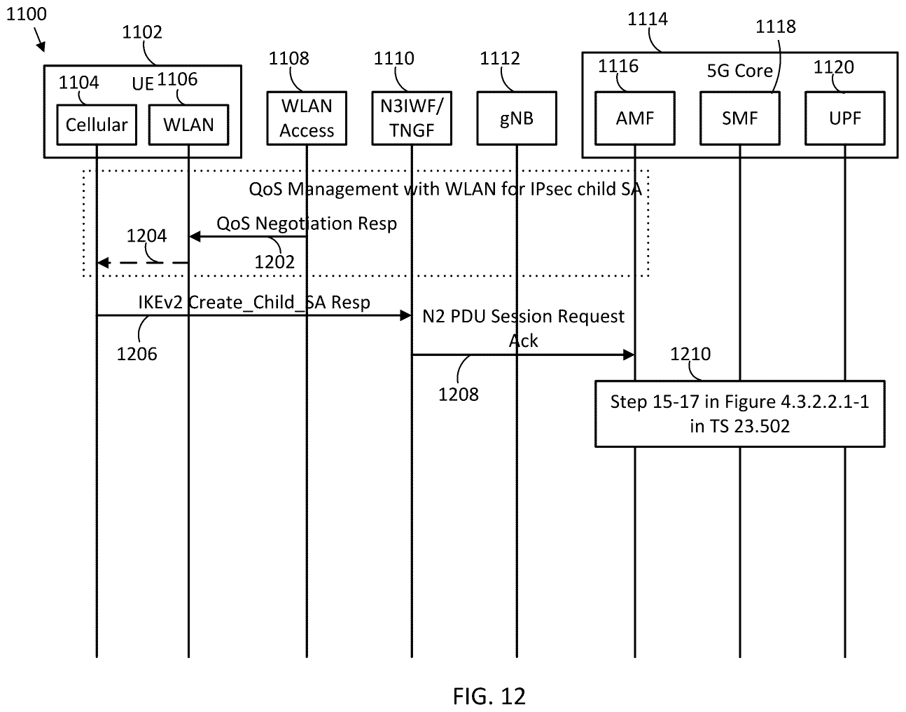

FIG. 11 illustrates a first portion of an example signaling chart 1100 for a device centric QoS management approach in accordance with some embodiments. FIG. 12 illustrates a second portion of the example signaling chart 1100 of FIG. 11 in accordance with some embodiments. For example, signaling chart 1100 illustrates example signaling for a system that implements device centric QoS management with WLAN during multi-access-protocol data unit (MA-PDU) session establishment.

This option may provide QoS prioritization within WLAN for 5G flows for cases when DSCP markings either are not added by N3IWF/TNGF or stripped off by the network segment before reaching WLAN AP. This option can provide additional QoS info (e.g., throughput, latency) for 5G QoS flows to WLAN AP network which can be used for resource reservation. This option requires enhancement to support QoS management between STA and AP for 5G flows.

The signaling chart 1100 may include a UE 1102. The UE 1102 may include one or more of the features of the UE 102 (FIG. 1), the UE 202 (FIG. 2), the UE 402 (FIG. 4), the UE 502 (FIG. 5), and/or the UE 1800 (FIG. 18). The UE 1102 may include a cellular element 1104 and a WLAN element 1106. The cellular element 1104 may include one or more of the features of the 3GPP stack 504 (FIG. 5). The WLAN element 1106 may include one or more of the features of the WLAN STA 506 (FIG. 5).

The signaling chart 1100 may include a WLAN access point 1108. The WLAN access point 1108 may be a trusted WLAN access point or an untrusted WLAN access point. The WLAN access point 1108 may include one or more of the features of the untrusted non-3GPP access point 110 (FIG. 1), the trusted non-3GPP access point 210 (FIG. 2), the untrusted WLAN access point 404 (FIG. 4), and/or the WLAN access point 510 (FIG. 5).

The signaling chart 1100 may include a gateway function 1110. The gateway function 1110 may be an N3IWF or a TNGF. The gateway function 1110 may include one or more of the features of the N3IWF 104 (FIG. 1), the TNGF 204 (FIG. 2), the N3IWF 406 (FIG. 4), and/or the gateway function 512 (FIG. 5).

The signaling chart 1100 may include a base station 1112. The base station 1112 may include one or more of the features of the 3GPP access point 108 (FIG. 1), the 3GPP access point 208 (FIG. 2), the 3GPP RAN node 508 (FIG. 5), and/or the gNB 1900 (FIG. 19).

The signaling chart 1100 may include a core network 1114. The core network 1114 may be an EPC and/or a 5GC network. The core network 1114 may include an AMF 1116, a session management function (SMF) 1118, and a UPF 1120. The AMF 1116 may include one or more of the features of the AMF 408 (FIG. 4), and/or the AMF 516 (FIG. 5). The SMF 1118 may collect information related to PDU session management and/or control one or more of the elements of the core network 1114. The UPF 1120 may include one or more of the features of the UPF 114 (FIG. 1), the UPF 214 (FIG. 2), and/or the UPF 518 (FIG. 5).

The UE 1102 may establish a PDU session and/or an MA-PDU session with the core network 1114. For example, the cellular element 1104 may transmit a PDU session establishment request 1122 to the AMF 1116. The PDU session establishment request 1122 may include an MA-PDU request. The AMF 1116 may respond to the cellular element 1104 with a PDU session establishment accept 1124. During (MA-)PDU session establishment involving WLAN access, UE can initiate QoS management with WLAN AP for 5G flows. For example, the UE 1102 can initiate QoS management with WLAN for IPsec child SA 1142 during the establishment of the PDU session and/or the MA-PDU session.

The core network 1114 may perform one or more operations for the PDU session establishment in 1126. For example, the core network 1114 may perform steps 2 through 20 shown from figure 4.3.2.1.1-1 from TS 23.502 (3^{rd} Generation Partnership Project; Technical Specification Group Services and System Aspects; Procedures for the 5G System (5GS); Stage 2 (Release 18). (2023-06). 3GPP TS 23.502, 18.2.0) with changes from clause 4.22.2.1 in TS 23.502 (Id.).

The AMF 1116 may transit an N2 PDU session request 1128 to the gateway function 1110. The gateway function 1110 may transmit an IKE create child SA request (IKEv2 Create_Child_SA Req) 1130 to the cellular element 1104 as part of an IKEv2 child SA establishment. During IKEv2 Child SA establishment, 5G QoS characteristics may be sent to the UE. For example, the IKEv2 Create_Child_SA Req 1130 may include a 5G QoS information payload (5G_QOS_INFO payload). The 5G_QOS_INFO payload may include 5G QoS characteristics.

The UE 1102 can map 5G QoS characteristics to DSCP (if no DSCP received) and then map DSCP to 802.11 UP/AC. For example, the cellular element 1104 may map 5QI to DSCP in 1132. The cellular element 1104 may provide the DSCP values from the 5QI to DSCP mapping, an indication of the DSCP values to be prioritized, and/or an indication that the 5QI to DSCP mapping has been completed to the WLAN element 1106 in 1134. The WLAN element 1106 may map the DSCP to WLAN protocol in 1136. In some embodiments, the WLAN protocol may be 802.11 UP/AC.

For DL flows, UE can use enhanced protocol (R2) to negotiate QoS prioritization with WLAN AP (e.g., AC_VO or AC_VI). This message can also provide 5G QoS information to WLAN for resource reservation. For example, the WLAN element 1106 of the UE 1102 may transmit a QoS negotiation request 1138 to the WLAN access point 1108. The QoS negotiation request 1138 may include QoS information. For example, the QoS negotiation request 1138 may include a traffic identifier, a scheduling priority indicator (SPI) for IPsec, a request, and/or UP/AC information.

QoS prioritization on WLAN AP can be based on SPI value, Destination Address, and/or Security Protocol Id (ESP). For example, the WLAN access point 1108 may determine whether to prioritize signals and/or messages sent by the WLAN access point 1108 based on the SPI value, the destination address, and/or the security protocol Id. As a result, WLAN AP maps DL traffic for IPsec child SAs to appropriate 802.11 UP/AC as negotiated. For example, the WLAN access point 1108 may map the DL IPsec SA traffic to the appropriate WLAN protocol in 1140. In some embodiments, the WLAN protocol may be 802.11 UP/AC. The mapping of the DL IPsec SA traffic to the appropriate WLAN protocol may be based on the SPI value, the destination address, and/or the security protocol Id.

The WLAN access point 1108 can transmit a QoS negotiation response 1202 to the WLAN element 1106 of the UE 1102. The QoS negotiation response may indicate whether the QoS negotiation request 1138 has been accepted or rejected. WLAN AP can reject QoS Request from UE, if it cannot admit flow for the requested AC—results in failure to establish IPsec child SA over WLAN access. For example, the QoS negotiation response 1202 transmitted by the WLAN access point 1108 may indicate that the QoS negotiation request 1138 has been rejected if the WLAN access point 1108 cannot admit flow for the AC requested by the QoS negotiation request 1138. This rejection may result in failure to establish an IPsec child SA over the WLAN access point 1108.

The WLAN element 1106 may provide an indication to the cellular element 1104 whether the QoS negotiation request 1138 has been accepted or rejected in 1204. If the QoS negotiation request 1138 has been accepted, the cellular element 1104 may transmit an IKE create child SA response (IKEv2 Create_Child_SA Resp) 1206 to the gateway function 1110 to establish the IPsec SA. The gateway function 1110 may transmit an N2 PDU session request acknowledgement 1208 to the AMF 1116 of the core network 1114. In 1210, the core network 1114 may perform steps 15 through 17 in figure 4.3.2.2.1-1 in TS 23.502 (3^{rd} Generation Partnership Project; Technical Specification Group Services and System Aspects; Procedures for the 5G System (5GS); Stage 2 (Release 18). (2023-06). 3GPP TS 23.502, 18.2.0) to complete the IPsec SA establishment.

This model can also be applied for prioritizing NAS over signaling IPsec SA within WLAN. During signaling IPsec SA establishment, a DSCP value can be sent to the UE using a Notify Payload over IKE_AUTH messaging. For example, the IKEv2 Create_Child_SA request 1130 may include a notify payload that indicates a DSCP value in some embodiments. In other embodiments, another message related to IKE messaging that is transmitted to the UE 1102 may include a notify payload with a DSCP value. UE can map this DSCP to 802.11 UP/AC. For example, the UE 1102 can map the DSCP value indicated in the notify payload to a WLAN protocol. In some embodiments, the WLAN protocol may be 802.11 UP/AC.

As a result, WLAN AP may map DL traffic for signaling IPsec SA traffic to appropriate 802.11 UP/AC as negotiated, resulting in priority transmission for NAS messaging. For example, the WLAN access point 1108 may map DL traffic for signaling IPsec SA traffic to the appropriate WLAN protocol. In some embodiments, the WLAN protocol may be 802.11 UP/AC. This may result in priority transmission for NAS messaging for the UE 1102.

Although the signals and operations of the signaling chart 1100 are shown in a particular order in the illustrated embodiment, it should be understood that one or more of the signals and/or operations may be performed in a different order and/or performed concurrently in other embodiments. Further, it should be understood that one or more of signals and/or operations may be omitted, and/or one or more additional signals and/or operations may be performed in other embodiments.

### Approach for MPS Over WLAN—3: Network Centric E2E QoS Model for Trusted WLAN

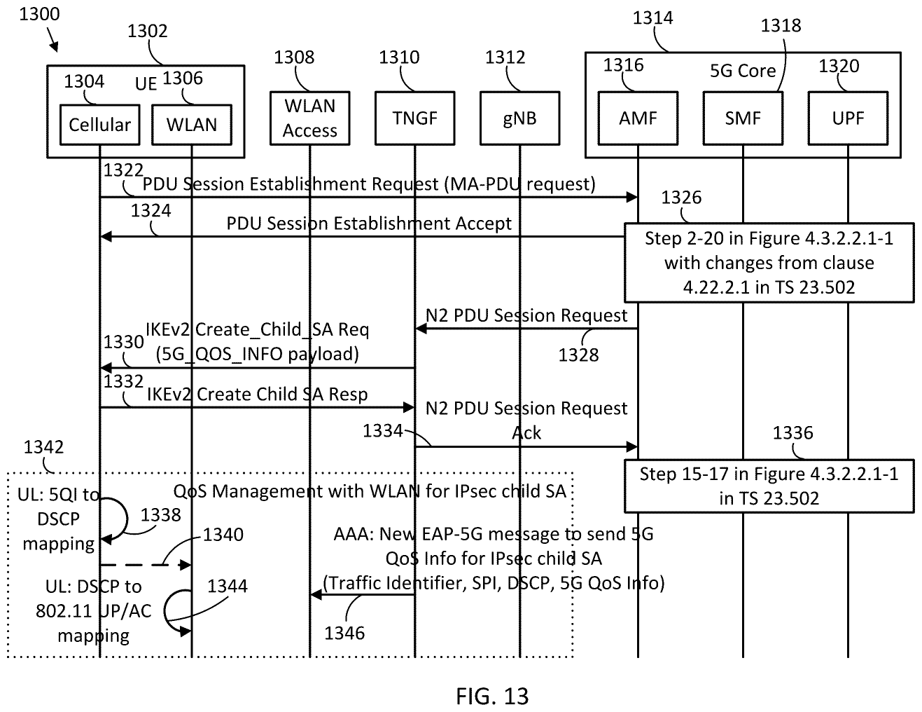

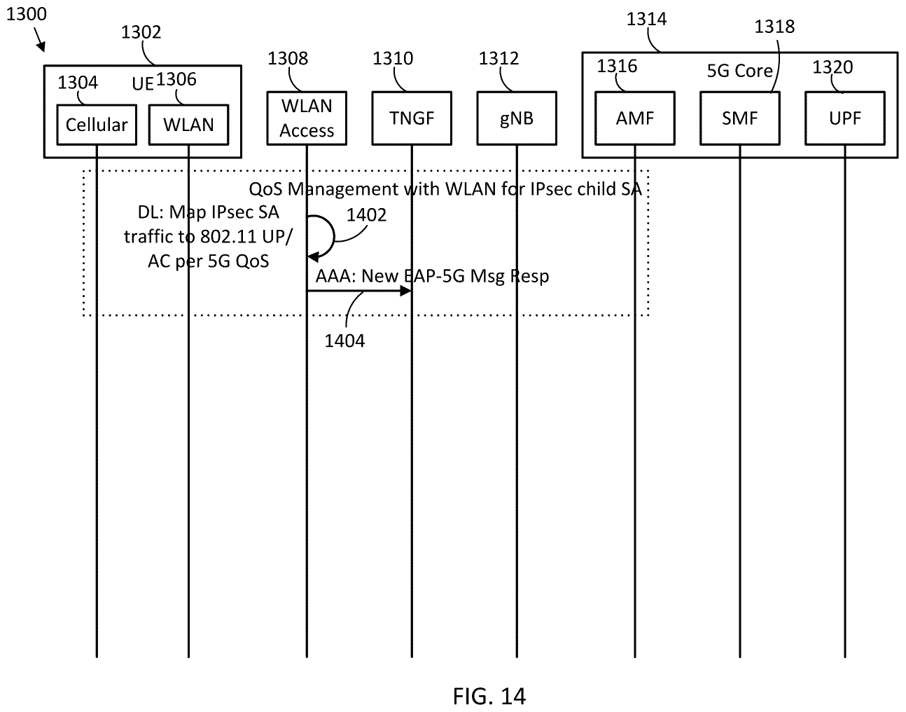

FIG. 13 illustrates a first portion of an example signaling chart 1300 for a network centric QoS management approach in accordance with some embodiments. FIG. 14 illustrates a second portion of the example signaling chart 1300 of FIG. 13 in accordance with some embodiments. For example, signaling chart 1300 illustrates example signaling for a system that implements network centric QoS management with WLAN during MA-PDU session establishment.

This option may be applicable for trusted WLAN integration deployment and may provide QoS prioritization within WLAN for 5G flows for cases when DSCP markings either are not added by TNGF or stripped off by the network segment before reaching WLAN AP. The approach can provide additional QoS information (e.g., throughput, latency) for 5G QoS flows to WLAN AP network which can be used for resource reservation and requires enhancement to EAP-5G protocol to carry 5G QoS Information and other related parameters over authentication, authorization, and accounting (AAA) based Ta interface.

The signaling chart 1300 may include a UE 1302. The UE 302 may include one or more of the features of the UE 102 (FIG. 1), the UE 202 (FIG. 2), the UE 402 (FIG. 4), the UE 502 (FIG. 5), the UE 1102 (FIG. 11), and/or the UE 1800 (FIG. 18). The UE 1302 may include a cellular element 1304 and a WLAN element 1306. The cellular element 1304 may include one or more of the features of the 3GPP stack 504 (FIG. 5) and/or the cellular element 1104 (FIG. 11). The WLAN element 1306 may include one or more of the features of the WLAN STA 506 (FIG. 5) and/or the WLAN element 1106 (FIG. 11).

The signaling chart 1300 may be applicable for trusted WLAN integration. For example, the signaling chart 1300 may include a WLAN access point 1308. The WLAN access point 1308 may be a trusted WLAN access point. The WLAN access point 1308 may include one or more of the features of the trusted non-3GPP access point 210 (FIG. 2), the WLAN access point 510 (FIG. 5), and/or the WLAN access point 1108 (FIG. 11).

The signaling chart 1300 may include a TNGF 1310. The TNGF 1310 may include one or more of the features of the TNGF 204 (FIG. 2), the gateway function 512 (FIG. 5), and/or the gateway function 1110 (FIG. 11).

The signaling chart 1300 may include a base station 1312. The base station 1312 may include one or more of the features of the 3GPP access point 108 (FIG. 1), the 3GPP access point 208 (FIG. 2), the 3GPP RAN node 508 (FIG. 5), the base station 1112 (FIG. 11), and/or the gNB 1900 (FIG. 19).

The signaling chart 1300 may include a core network 1314. The core network 1314 may be an EPC and/or a 5GC network. The core network 1314 may include an AMF 1316, an SMF 1318, and a UPF 1320. The AMF 1316 may include one or more of the features of the AMF 408 (FIG. 4), the AMF 516 (FIG. 5), and/or the AMF 1116 (FIG. 11). The SMF 1318 may include one or more of the features of the SMF 1118 (FIG. 11). The UPF 1320 may include one or more of the features of the UPF 114 (FIG. 1), the UPF 214 (FIG. 2), the UPF 518 (FIG. 5), and/or the UPF 1120 (FIG. 11).

The UE 1302 may establish a PDU session and/or an MA-PDU session with the core network 1314. For example, the cellular element 1304 may transmit a PDU session establishment request 1322 to the AMF 1316. The PDU session establishment request 1322 may include an MA-PDU request. The AMF 1316 may respond to the cellular element 1304 with a PDU session establishment accept 1324. During MA-PDU session establishment, TNGF can initiate QoS management with WLAN AP for 5G flows sent over IPsec Child SAs. For example, the TNGF 1310 can initiate QoS management with WLAN for IPsec child SA 1342 during the establishment of the PDU session and/or the MA-PDU session.

The core network 1314 may perform one or more operations for the PDU session establishment in 1326. For example, the core network 1314 may perform steps 2 through 20 shown from figure 4.3.2.1.1-1 from TS 23.502 (3^{rd} Generation Partnership Project; Technical Specification Group Services and System Aspects; Procedures for the 5G System (5GS); Stage 2 (Release 18). (2023-06). 3GPP TS 23.502, 18.2.0) with changes from clause 4.22.2.1 in TS 23.502 (Id.).

The AMF 1316 may transit an N2 PDU session request 1328 to the TNGF 1310. During signaling IPsec SA establishment, a DSCP value can be sent to the UE using a Notify Payload over IKE_AUTH messaging. For example, the TNGF 1310 may transmit an IKE create child SA request (IKEv2 Create_Child_SA Req) 1330 to the cellular element 1304 as part of an IKEv2 child SA establishment. The IKEv2 Create_Child_SA Req 1330 may include a 5G QoS information payload (5G_QOS_INFO payload). The 5G_QOS_INFO payload may include 5G QoS characteristics. Further, the 5G QoS information payload may include a DSCP value, where the 5G QoS information payload may operate as a notify payload.

The cellular element 1304 may transmit an IKE create child SA response (IKEv2 Create_Child_SA Resp) 1332 to the TNGF 1310 to establish the IPsec SA. The TNGF 1310 may transmit an N2 PDU session request acknowledgement 1334 to the AMF 1316 of the core network 1314. In 1336, the core network 1314 may perform steps 15 through 17 in figure 4.3.2.2.1-1 in TS 23.502 (3^{rd} Generation Partnership Project; Technical Specification Group Services and System Aspects; Procedures for the 5G System (5GS); Stage 2 (Release 18). (2023-06). 3GPP TS 23.502, 18.2.0) to complete the IPsec SA establishment.

The UE 1302 can map 5G QoS characteristics to DSCP. For example, the cellular element 1304 may map 5QI to DSCP in 1338. The cellular element 1304 may provide the DSCP values from the 5QI to DSCP mapping, an indication of the DSCP values to be prioritized, and/or an indication that the 5QI to DSCP mapping has been completed to the WLAN element 1306 in 1340. For UL, UE can map this DSCP to 802.11 UP/A. For example, the WLAN element 1306 may the DSCP to WLAN protocol in 1344. In some embodiments, the WLAN protocol may be 802.11 UP/AC.

TNGF can send 5G QoS Information (such as Traffic Identifier, SPI, and/or DSCP) to WLAN AP over AAA interface (Ta) using a new EAP-5G signaling message (TS 24.502). For example, the TNGF 1310 may transmit an EAP-5G signaling message 1346 to the WLAN access point 1308. The EAP-5G signaling message 1346 may be in accordance with EAP-5G signaling as defined by TS 24.502 (3^{rd} Generation Partnership Project; Technical Specification Group Core Network and Terminals; Access to the 3GPP 5G Core Network (5GCN via Non-3GPP Access Networks (N3AN); Stage 3 (Release 18). (2023-06). 3GPP TS 24.502, 18.2.0). The EAP-5G signaling message 1346 may include QoS information, such as a traffic identifier, an SPI, a DSCP value, and/or other 5G QoS information. EAP-5G messages may be carried over AAA using already defined RADIUS EAP-message attribute. For example, the EAP-5G signaling message 1346 be carried over an AAA interface using the RADIUS EAP-message attribute. In some embodiments, N3IWF/TNGF can send 5G QoS Info (such Traffic Identifier, SPI and DSCP) to WLAN AP over AAA interface (Ta) using the new EAP-5G signaling message.

WLAN AP can map DL IPsec SA traffic to appropriate 802.11 UP/AC based on DSCP value. 5G QoS characteristics received can be used for WLAN resource reservation. DL QoS prioritization on WLAN AP can be based on triplet (SPI value, Destination Address, Security Protocol Identifier (ESP)). For example, the WLAN access point 1308 may map IPsec SA traffic in a DL direction to a WLAN protocol in 1402. In some embodiments, the WLAN protocol may be 802.11 UP/AC. The mapping of the IPsec SA traffic to the WLAN protocol may be based on the DSCP value associated with the traffic. As a result, WLAN AP may map DL signaling IPsec SA traffic to appropriate 802.11 UP/AC based on DSCP value. For example, the WLAN access point 1308 may map DL signaling IPsec SA traffic to an appropriate WLAN protocol. In some embodiments, the IPsec SA traffic to WLAN protocol mapping may be per 5G QoS. The QoS prioritization for the IPsec SA traffic to WLAN protocol may be based on an SPI value associated with the traffic, a destination address of the traffic, and/or a security protocol identifier associated with the traffic. 5G QoS characteristics received can be used for WLAN resource reservation. For example, the SPI value, the destination address, and/or the security protocol identifier may be utilized for reserving WLAN resources for transmitting the traffic.

The WLAN access point 1308 may transmit an EAP-5G message response 1404 to the TNGF 1310. The EAP-5G message response 1404 may indicate that the EAP-5G signaling message 1346. This model can also be applied for prioritizing NAS over signaling IPsec SA within WLAN. The EAP-5G message response 1404 may be in accordance with EAP-5G signaling as defined by TS 24.502 (3^{rd} Generation Partnership Project; Technical Specification Group Core Network and Terminals; Access to the 3GPP 5G Core Network (5GCN via Non-3GPP Access Networks (N3AN); Stage 3 (Release 18). (2023-06). 3GPP TS 24.502, 18.2.0). EAP-5G messages may be carried over AAA using already defined RADIUS EAP-message attribute. For example, the EAP-5G message response 1404 may be carried over an AAA interface using the RADIUS EAP-message attribute.

This model can also be applied for prioritizing NAS over signaling IPsec SA within WLAN. For example, the signals and/or operations shown in the signaling chart 1300 may also be utilized for prioritizing NAS over signaling IPsec SA within WLAN.

Although the signals and operations of the signaling chart 1300 are shown in a particular order in the illustrated embodiment, it should be understood that one or more of the signals and/or operations may be performed in a different order and/or performed concurrently in other embodiments. Further, it should be understood that one or more of signals and/or operations may be omitted, and/or one or more additional signals and/or operations may be performed in other embodiments.

### Open Points

There may be some points to be addressed, including the following. UE may not aware be of WLAN MPS like shared in Registration Accept in 3GPP to know if it can use MPS in next access. Like CUC in 3GPP, there may be no mechanism to update MPS in WLAN dynamically. For Authentication and Authorization, what is the outcome of Authentication/Authorization failure specific to MPS? There may be an indication provided back to UE.

The initial access to network and authorization when WLAN is congested, UE which is not yet authorized by network may not be able to access network even when it has valid user credentials associated with the UE (e.g., a calling card number, PIN, or security token). For WLAN access, the UE may notify the TNAN/N3IWF of its MPS subscription before the NAS Registration Request. Based on operator policy, the TNAN/N3IWF may use this indication to provide the UE with priority treatment in the case of congestion overload before acceptance of the NAS Registration Request with an MPS priority establishment cause.

When UE does not have universal integrated circuit card (UICC), service user credentials not associated with the UE (e.g., a calling card number, PIN, or security token) may be used. AP may be able to define if it is MPS in standardized interface. Authentication and Authorization: For a UE with a 3GPP subscription for MPS and with WLAN access to the EPC/5GC, the system may support MPS for MMTEL voice/video authorization based on the UE subscription information. For a UE that does not have a 3GPP subscription for MPS and with WLAN access to the EPC/5GC, the system may support MPS for MMTEL voice/video authorization based on Service User credentials not associated with the UE (e.g., a calling card number, PIN, or security token).

MPS for MMTEL voice and video and MPS for DTS (Data Transport Service) may be handled as separate features. MPS priority may be shared with N3IWF from UDM/AUSF. MPS priority may be shared with TNAN from UDM/AUSF.

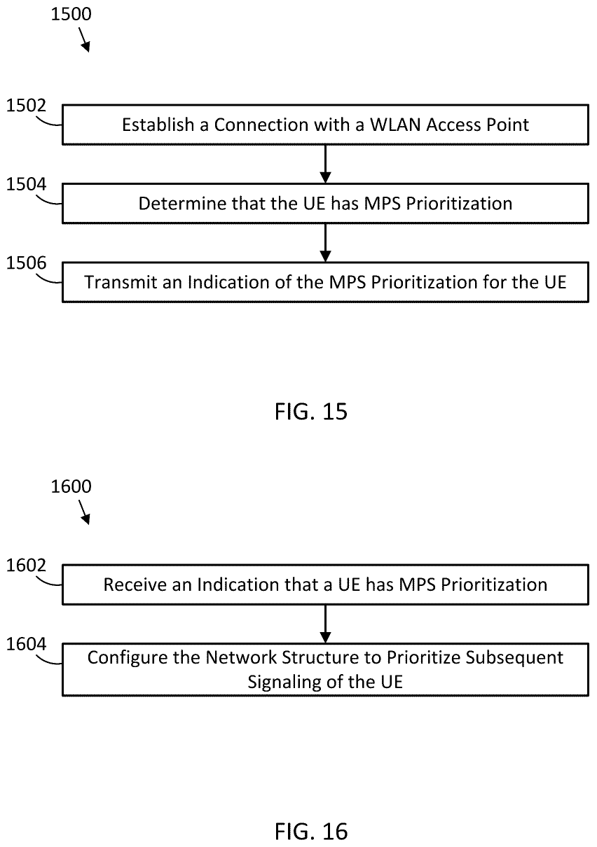

FIG. 15 illustrates an example procedure 1500 to be performed by a UE in accordance with some embodiments. For example, the procedure 1500 may be performed by the UE 102 (FIG. 1), the UE 202 (FIG. 2), the UE 402 (FIG. 4), the UE 502 (FIG. 5), the UE 1102 (FIG. 11), the UE 1302 (FIG. 13), and/or the UE 1800 (FIG. 18). The UE may perform the procedure 1500 for facilitating prioritization of signals via WLAN in accordance with MPS prioritization.

The procedure 1500 may include establishing a connection with a WLAN access point in 1502. For example, the UE may establish a connection with a WLAN access point for accessing a network. The WLAN access point may include one or more of the features of the untrusted non-3GPP access point 110 (FIG. 1), the trusted non-3GPP access point 210 (FIG. 2), the WLAN access point 510 (FIG. 5), the WLAN access point 1108 (FIG. 11), and/or the WLAN access point 1308 (FIG. 13). The network may include an EPC network and/or a 5G network. Further, the network may include a core network (such as the core network 514 (FIG. 5), the core network 1114 (FIG. 11), and/or the core network 1314 (FIG. 13)) that can provide services to the UE via the WLAN access point.

The WLAN access point may be an untrusted WLAN access point or a trusted WLAN access point in some embodiments. For example, the WLAN access point may be an untrusted WLAN access point in some embodiments or a trusted WLAN access point in other embodiments.

The procedure 1500 may include determining that the UE has MPS prioritization in 1504. For example, the UE may determine that the UE has MPS prioritization to indicate that services of the UE are to be prioritized.

The procedure 1500 may include transmitting an indication of the MPS prioritization for the UE. For example, the UE may transmit, to the WLAN access point, an indication of the MPS prioritization for the UE.

In some embodiments, the indication of the MPS prioritization may be included in an Internet Key Exchange Authorization (IKE_AUTH) request. For example, the indication of the MPS prioritization can be transmitted in an IKE exchange, such as the IKE exchange of 416 (FIG. 4). In some of these embodiments, the indication of the MPS prioritization may be included in a notify payload of the IKE_AUTH request. Further, the WLAN access point may include an untrusted WLAN access point in some of these embodiments, and the indication of the MPS prioritization may be included in the IKE_AUTH request based at least in part on the WLAN access point including the untrusted WLAN access point.

In some embodiments, the indication of the MPS prioritization may be included in a username part of a NAI. In some of these embodiments, the WLAN access point may include a trusted WLAN access point, and the indication of the MPS prioritization may be included in the username part of the NAI based at least in part on the WLAN access point including the trusted WLAN access point.

In some embodiments, the procedure 1500 may include transmitting an indication of an establishment cause. For example, the UE may transmit, to the WLAN access point, an indication of an establishment cause. The establishment cause may be utilized for determining a DSCP value for subsequent signaling related to the UE.

In some embodiments, the procedure 1500 may include applying a QI to DSCP mapping to signaling. For example, the UE may apply, via a 3GPP stack of the UE, a QI to DSCP mapping to signaling to prioritize the signaling between the 3GPP stack and a WLAN STA of the UE.

In some embodiments, the procedure 1500 may include applying a DSCP to a WLAN protocol mapping. For example, the UE may apply, via a WLAN STA of the UE to signaling for the UE, a DSCP to WLAN protocol mapping to prioritize the signaling between the UE and the WLAN access point.

Although FIG. 15 arguably implies an order of the operations within the procedure 1500, it should be understood that one or more of the operations may be performed in a different order and/or concurrently in other embodiments. Further, it should be understood that one or more of the operations may be omitted from the procedure 1500, and/or one or more additional operations may be included in the procedure 1500, in other embodiments.

FIG. 16 illustrates an example procedure 1600 to be performed by a network structure in accordance with some embodiments. For example, the network structure may include a WLAN access point (such as the untrusted non-3GPP access point 110 (FIG. 1), the trusted non-3GPP access point 210 (FIG. 2), the untrusted WLAN access point 404 (FIG. 4), the WLAN access point 510 (FIG. 5), the WLAN access point 1108 (FIG. 11), and/or the WLAN access point 1308 (FIG. 13)), a gateway function (such as the N3IWF 104 (FIG. 1), the TNGF 204 (FIG. 2), the N3IWF 406 (FIG. 4), the gateway function 512 (FIG. 5), the gateway function 1110 (FIG. 11), and/or the TNGF 1310 (FIG. 13)), a core network (such as the core network 514 (FIG. 5), the core network 1114 (FIG. 11), and/or the core network 1314 (FIG. 13)), an AMF (such as the AMF 408 (FIG. 4)), an AUSF (such as the AUSF 410 (FIG. 4)), or some combination thereof. The elements included in the network structure may differ in different embodiments. The network structure may perform the procedure 1600 for facilitating prioritization of signals via WLAN in accordance with MPS prioritization.

The procedure 1600 may include receiving an indication that a UE has MPS prioritization in 1602. For example, the network structure may receive, via a WLAN access point of the network structure from a UE, an indication that the UE has MPS prioritization. For example, the network structure may receive the indication as part of the IKE exchange in 416 (FIG. 4).

In some embodiments, the indication that the UE has MPS prioritization may be received in an Internet Key Exchange Authorization (IKE_AUTH) request. In some of these embodiments, the indication that the UE has MPS prioritization may be received in a notify payload of the IKE_AUTH request.

In some embodiments, the indication that the UE has MPS prioritization may be received in a username part of an NAI.

In some embodiments, the procedure 1600 may include receiving an indication of an establishment cause. For example, the network structure may receive, from the UE, an indication of an establishment cause.

In some embodiments, the procedure 1600 may include determining a DSCP value for subsequent signaling. For example, the network structure may determine a DSCP value for subsequent signaling of the UE.

The procedure 1600 may include configuring the network structure to prioritize subsequent signaling of the UE in 1604. For example, the network structure may configure the network structure to prioritize subsequent signaling of the UE via the WLAN access point based at least in part on the indication that the UE has MPS prioritization.

In some embodiments, configuring the network structure may include generating a QI to DSCP mapping for the subsequent signaling of the UE based at least in part on the indication that the UE has MPS prioritization. Further, configuring the network structure may include applying, via an N3IWF or a TNGF to the subsequent signaling, the QI to DSCP mapping to prioritize the subsequent signaling between the N3IWF or the TNGF and the WLAN access point in some embodiments.

In some embodiments, configuring the network structure may include generating a DSCP to a WLAN protocol mapping for the subsequent signaling of the UE based at least in part on the indication that the UE has MPS prioritization. Further, configuring the network structure may include applying, via the WLAN access point to the subsequent signaling, the DSCP to the WLAN protocol mapping to prioritize the subsequent signaling between the WLAN access point and the UE in some embodiments.

Although FIG. 16 arguably implies an order of the operations within the procedure 1600, it should be understood that one or more of the operations may be performed in a different order and/or concurrently in other embodiments. Further, it should be understood that one or more of the operations may be omitted from the procedure 1600, and/or one or more additional operations may be included in the procedure 1600, in other embodiments.

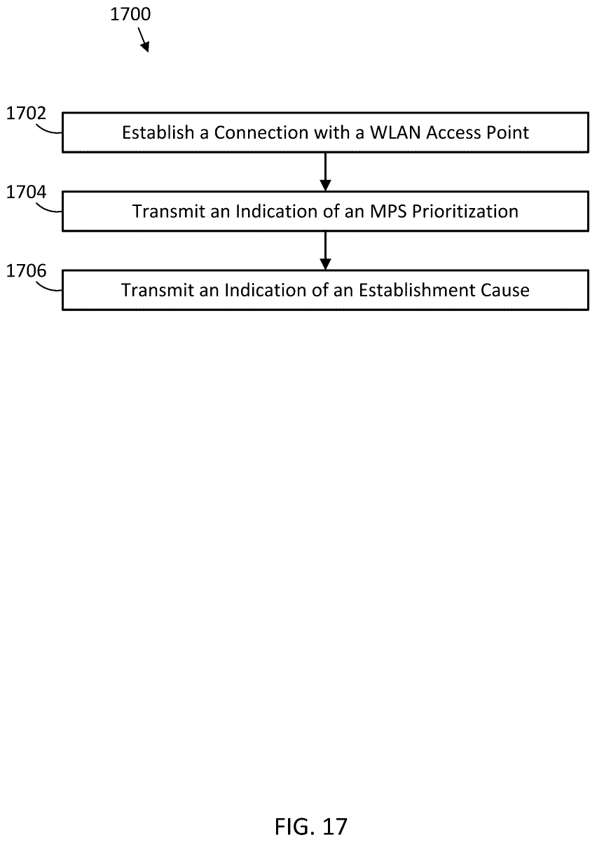

FIG. 17 illustrates an example procedure 1700 to be performed by a UE in accordance with some embodiments. For example, the procedure 1700 may be performed by the UE 102 (FIG. 1), the UE 202 (FIG. 2), the UE 402 (FIG. 4), the UE 502 (FIG. 5), the UE 1102 (FIG. 11), the UE 1302 (FIG. 13), and/or the UE 1800 (FIG. 18). The UE may perform the procedure 1700 for facilitating prioritization of signals via WLAN in accordance with MPS prioritization.

The procedure 1700 may include establishing a connection with a WLAN access point in 1702. For example, the UE may establish a connection with a WLAN access point of a network. The WLAN access point may include one or more of the features of the untrusted non-3GPP access point 110 (FIG. 1), the trusted non-3GPP access point 210 (FIG. 2), the WLAN access point 510 (FIG. 5), the WLAN access point 1108 (FIG. 11), and/or the WLAN access point 1308 (FIG. 13). The network may include an EPC network and/or a 5G network. Further, the network may include a core network (such as the core network 514 (FIG. 5), the core network 1114 (FIG. 11), and/or the core network 1314 (FIG. 13)) that can provide services to the UE via the WLAN access point.

The WLAN access point may be part of an untrusted WLAN network or part of a trusted WLAN network in some embodiments. For example, the WLAN access point may be part of an untrusted WLAN network in some embodiments or part of a trusted WLAN network in other embodiments.

The procedure 1700 may include transmitting an indication of an MPS prioritization in 1704. For example, the UE may transmit, to the WLAN access point, an indication of an MPS prioritization to indicate that services of the UE are to be prioritized.

In some embodiments, the WLAN access point may be part of an untrusted WLAN network, and the indication of the MPS prioritization may be transmitted in an Internet Key Exchange Authorization (IKE_AUTH) request based at least in part on the WLAN access point being part of the untrusted WLAN network. For example, the IKE_AUTH may be part of the IKE exchange of 416 (FIG. 4). In some of these embodiments, the indication of the MPS prioritization may be included in a notify payload of the IKE_AUTH request.

In some embodiments, the WLAN access point may be part of a trusted WLAN network, and the indication of the MPS prioritization is transmitted in a username part of an NAI based at least in part on the WLAN access point being part of the trusted WLAN network.

The procedure 1700 may include transmitting an indication of an establishment cause in 1706. For example, the UE may transmit, to the WLAN access point, an indication of an establishment cause. The establishment cause may be utilized for determining a DSCP value for prioritizing signaling related to the UE.

Although FIG. 17 arguably implies an order of the operations within the procedure 1700, it should be understood that one or more of the operations may be performed in a different order and/or concurrently in other embodiments. Further, it should be understood that one or more of the operations may be omitted from the procedure 1700, and/or one or more additional operations may be included in the procedure 1700, in other embodiments.

FIG. 18 illustrates an example UE 1800 in accordance with some embodiments. The UE 1800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1800 may be a RedCap UE or NR-Light UE.

The UE 1800 may include processors 1804, RF interface circuitry 1808, memory/storage 1812, user interface 1816, sensors 1820, driver circuitry 1822, power management integrated circuit (PMIC) 1824, antenna structure 1826, and battery 1828. The components of the UE 1800 may be implemented as integrated circuits (ICs), portions thereof, discrete electronic devices, or other modules, logic, hardware, software, firmware, or a combination thereof. The block diagram of FIG. 18 is intended to show a high-level view of some of the components of the UE 1800. However, some of the components shown may be omitted, additional components may be present, and different arrangement of the components shown may occur in other implementations.

The components of the UE 1800 may be coupled with various other components over one or more interconnects 1832, which may represent any type of interface, input/output, bus (local, system, or expansion), transmission line, trace, optical connection, etc. that allows various circuit components (on common or different chips or chipsets) to interact with one another.

The processors 1804 may include processor circuitry such as, for example, baseband processor circuitry (BB) 1804A, central processor unit circuitry (CPU) 1804B, and graphics processor unit circuitry (GPU) 1804C. The processors 1804 may include any type of circuitry or processor circuitry that executes or otherwise operates computer-executable instructions, such as program code, software modules, or functional processes from memory/storage 1812 to cause the UE 1800 to perform operations as described herein.

In some embodiments, the baseband processor circuitry 1804A may access a communication protocol stack 1836 in the memory/storage 1812 to communicate over a 3GPP compatible network. In general, the baseband processor circuitry 1804A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1808.

The baseband processor circuitry 1804A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1812 may include one or more non-transitory, computer-readable media that includes instructions (for example, communication protocol stack 1836) that may be executed by one or more of the processors 1804 to cause the UE 1800 to perform various operations described herein. The memory/storage 1812 include any type of volatile or non-volatile memory that may be distributed throughout the UE 1800. In some embodiments, some of the memory/storage 1812 may be located on the processors 1804 themselves (for example, L1 and L2 cache), while other memory/storage 1812 is external to the processors 1804 but accessible thereto via a memory interface. The memory/storage 1812 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1808 may include transceiver circuitry and radio frequency front module (RFEM) that allows the UE 1800 to communicate with other devices over a radio access network. The RF interface circuitry 1808 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1826 and proceed to filter and amplify (with a low-noise amplifier) the signal. The signal may be provided to a receiver of the transceiver that down-converts the RF signal into a baseband signal that is provided to the baseband processor of the processors 1804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1826.

In various embodiments, the RF interface circuitry 1808 may be configured to transmit/receive signals in a manner compatible with NR access technologies.

The antenna structure 1826 may include antenna elements to convert electrical signals into radio waves to travel through the air and to convert received radio waves into electrical signals. The antenna elements may be arranged into one or more antenna panels. The antenna structure 1826 may have antenna panels that are omnidirectional, directional, or a combination thereof to enable beamforming and multiple input, multiple output communications. The antenna structure 1826 may include microstrip antennas, printed antennas fabricated on the surface of one or more printed circuit boards, patch antennas, phased array antennas, etc. The antenna structure 1826 may have one or more panels designed for specific frequency bands including bands in FR1 or FR2.

The user interface 1816 includes various input/output (I/O) devices designed to enable user interaction with the UE 1800. The user interface 1816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1800.

The sensors 1820 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1822 may include software and hardware elements that operate to control particular devices that are embedded in the UE 1800, attached to the UE 1800, or otherwise communicatively coupled with the UE 1800. The driver circuitry 1822 may include individual drivers allowing other components to interact with or control various input/output (I/O) devices that may be present within, or connected to, the UE 1800. For example, driver circuitry 1822 may include a display driver to control and allow access to a display device, a touchscreen driver to control and allow access to a touchscreen interface, sensor drivers to obtain sensor readings of sensor circuitry 1820 and control and allow access to sensor circuitry 1820, drivers to obtain actuator positions of electro-mechanic components or control and allow access to the electro-mechanic components, a camera driver to control and allow access to an embedded image capture device, audio drivers to control and allow access to one or more audio devices.

The PMIC 1824 may manage power provided to various components of the UE 1800. In particular, with respect to the processors 1804, the PMIC 1824 may control power-source selection, voltage scaling, battery charging, or DC-to-DC conversion.

In some embodiments, the PMIC 1824 may control, or otherwise be part of, various power saving mechanisms of the UE 1800. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1800 may power down for brief intervals of time and thus save power. If there is no data traffic activity for an extended period of time, then the UE 1800 may transition off to an RRC_Idle state, where it disconnects from the network and does not perform operations such as channel quality feedback, handover, etc. The UE 1800 goes into a very low power state and it performs paging where again it periodically wakes up to listen to the network and then powers down again. The UE 1800 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1828 may power the UE 1800, although in some examples the UE 1800 may be mounted deployed in a fixed location, and may have a power supply coupled to an electrical grid. The battery 1828 may be a lithium ion battery, a metal-air battery, such as a zinc-air battery, an aluminum-air battery, a lithium-air battery, and the like. In some implementations, such as in vehicle-based applications, the battery 1828 may be a typical lead-acid automotive battery.

FIG. 19 illustrates an example gNB 1900 in accordance with some embodiments. The gNB 1900 may include processors 1904, RF interface circuitry 1908, core network (CN) interface circuitry 1912, memory/storage circuitry 1916, and antenna structure 1926.

The components of the gNB 1900 may be coupled with various other components over one or more interconnects 1928.

The processors 1904, RF interface circuitry 1908, memory/storage circuitry 1916 (including communication protocol stack 1910), antenna structure 1926, and interconnects 1928 may be similar to like-named elements shown and described with respect to FIG. 18.

The CN interface circuitry 1912 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1900 via a fiber optic or wireless backhaul. The CN interface circuitry 1912 may include one or more dedicated processors or FPGAs to communicate using one or more of the aforementioned protocols. In some implementations, the CN interface circuitry 1912 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating a user equipment (UE) comprising establishing a connection with a wireless local area network (WLAN) access point for accessing a network, determining that the UE has multimedia priority service (MPS) prioritization to indicate that services of the UE are to be prioritized, and transmitting, to the WLAN access point, an indication of the MPS prioritization for the UE.

Example 2 may include the method of example 1, wherein the indication of the MPS prioritization is included in an Internet Key Exchange Authorization (IKE_AUTH) request.

Example 3 may include the method of example 2, wherein the indication of the MPS prioritization is included in a notify payload of the IKE_AUTH request.

Example 4 may include the method of example 2, wherein the WLAN access point includes an untrusted WLAN access point, and wherein the indication of the MPS prioritization is included in the IKE_AUTH request based at least in part on the WLAN access point including the untrusted WLAN access point.

Example 5 may include the method of example 1, wherein the indication of the MPS prioritization is included in a username part of a network access identifier (NAI).

Example 6 may include the method of example 5, wherein the WLAN access point includes a trusted WLAN access point, and wherein the indication of the MPS prioritization is included in the username part of the NAI based at least in part on the WLAN access point including the trusted WLAN access point.

Example 7 may include the method of example 1 comprising transmitting, to the WLAN access point, an indication of an establishment cause, the establishment cause to be utilized for determining a differentiated services codepoint (DSCP) value for subsequent signaling related to the UE.

Example 8 may include the method of example 1 comprising applying, via a third generation partnership project (3GPP) stack of the UE, a quality of service identifier (QI) to differentiated services codepoint (DSCP) mapping to signaling to prioritize the signaling between the 3GPP stack and a WLAN station (STA) of the UE.

Example 9 may include the method of example 1 comprising applying, via a WLAN station (STA) of the UE to signaling for the UE, a differentiated services codepoint (DSCP) to a WLAN protocol mapping to prioritize the signaling between the UE and the WLAN access point.

Example 10 may include a method of operating a network structure comprising receiving, via a wireless local area network (WLAN) access point of the network structure from a user equipment (UE), an indication that the UE has multimedia priority service (MPS) prioritization, and configuring the network structure to prioritize subsequent signaling of the UE via the WLAN access point based at least in part on the indication that the UE has MPS prioritization.

Example 11 may include the method of example 10, wherein the indication that the UE has MPS prioritization is received in an Internet Key Exchange Authorization (IKE_AUTH) request.

Example 12 may include the method of example 11, wherein the indication that the UE has MPS prioritization is received in a notify payload of the IKE_AUTH request.

Example 13 may include the method of example 10, wherein the indication that the UE has MPS prioritization is received in a username part of a network access identifier (NAI).

Example 14 may include the method of example 10 comprising receiving, from the UE, an indication of an establishment cause, and determining a differentiated services codepoint (DSCP) value for the subsequent signaling of the UE.

Example 15 may include the method of example 10, wherein configuring the network structure comprises generating a quality of service identifier (QI) to differentiated services codepoint (DSCP) mapping for the subsequent signaling of the UE based at least in part on the indication that the UE has MPS prioritization, and applying, via a non-third generation partnership project internetworking function (N3IWF) or a trusted non-third generation partnership project gateway function (TNGF) to the subsequent signaling, the QI to DSCP mapping to prioritize the subsequent signaling between the N3IWF or the TNGF and the WLAN access point.

Example 16 may include the method of example 10, wherein configuring the network structure comprises generating a differentiated services codepoint (DSCP) to a WLAN protocol mapping for the subsequent signaling of the UE based at least in part on the indication that the UE has MPS prioritization, and applying, via the WLAN access point to the subsequent signaling, the DSCP to the WLAN protocol mapping to prioritize the subsequent signaling between the WLAN access point and the UE.

Example 17 may include a method of operating a user equipment (UE) comprising establishing a connection with a wireless local area network (WLAN) access point of a network, transmitting, to the WLAN access point, an indication of a multimedia priority service (MPS) prioritization to indicate that services of the UE are to be prioritized, and transmitting, to the WLAN access point, an indication of an establishment cause, the establishment cause to be utilized for determining a differentiated services codepoint (DSCP) value for prioritizing signaling related to the UE.

Example 18 may include the method of example 17, wherein the WLAN access point is part of an untrusted WLAN network, and wherein the indication of the MPS prioritization is transmitted in an Internet Key Exchange Authorization (IKE_AUTH) request based at least in part on the WLAN access point being part of the untrusted WLAN network.

Example 19 may include the method of example 18, wherein the indication of the MPS prioritization is included in a notify payload of the IKE_AUTH request.

Example 20 may include the method of example 17, wherein the WLAN access point is part of a trusted WLAN network, and wherein the indication of the MPS prioritization is transmitted in a username part of a network access identifier (NAI) based at least in part on the WLAN access point being part of the trusted WLAN network.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
determine that a universal subscriber identity module (USIM) of a user equipment (UE) indicates that the UE is configured for priority access; and
generate a notify payload that indicates prioritization of the UE for transmission.

2. The one or more non-transitory, computer-readable media of claim 1, wherein the instructions, when executed, further cause the processing circuitry to:
generate an internet key exchange authentication (IKE_AUTH) request for transmission, wherein the IKE_AUTH request includes the notify payload.

3. The one or more non-transitory, computer-readable of claim 2, wherein the IKE_AUTH request is to be transmitted to an untrusted wireless local area network (WLAN) access point, and wherein the notify payload is included in the IKE_AUTH request based at least in part on transmission of the IKE_AUTH request to the untrusted WLAN access point.

4. The one or more non-transitory, computer-readable of claim 1, wherein the USIM indicates that the UE is configured for priority access based at least in part on multimedia priority service (MPS) subscription information stored in the USIM.

5. The one or more non-transitory, computer-readable of claim 4, wherein the instructions, when executed, further cause the processing circuitry to:
generate an indication of an establishment cause based on the MPS subscription information for transmission.

6. The one or more non-transitory, computer-readable of claim 1, wherein the instructions, when executed, further cause the processing circuitry to:
apply, via a wireless local area network (WLAN) station (STA) of the UE to signaling for the UE, a differentiated services codepoint (DSCP) to a WLAN protocol mapping to prioritize the signaling between the UE and a WLAN access point.

7. The one or more non-transitory, computer-readable of claim 1, wherein the instructions, when executed, further cause the processing circuitry to:
generate a network access identifier (NAI) for transmission, wherein the NAI includes an indication of prioritization of the UE.

8. The one or more non-transitory, computer-readable of claim 7, wherein the indication of prioritization of the UE is included in a username part of the NAI.

9. A method comprising:
identify a notify payload received from a user equipment (UE), the notify payload indicating prioritization of the UE; and
handle the UE with priority based at least in part on the prioritization.

10. The method of claim 9, wherein the UE is handled with priority after the UE is authenticated.

11. The method of claim 9, wherein the notify payload is received in an internet key exchange authentication (IKE_AUTH) request.

12. The method of claim 9, further comprising:
identifying an indication of an establishment cause received from the UE; and
determining a differentiated services codepoint (DSCP) value for subsequent signaling of the UE based at least in part on the establishment cause.

13. The method of claim 9, further comprising:
generating a quality of service identifier (QI) to differentiated services codepoint (DSCP) mapping for subsequent signaling of the UE based at least in part on the notify payload indicating prioritization; and
applying, via a non-third generation partnership project internetworking function (N3IWF) or a trusted non-third generation partnership project gateway function (TNGF) to the subsequent signaling, the QI to DSCP mapping to prioritize the subsequent signaling between the N3IWF or the TNGF and a wireless local area network (WLAN) access point.

14. The method of claim 9, further comprising:
generating a differentiated services codepoint (DSCP) to a wireless local area network (WLAN) protocol mapping for subsequent signaling of the UE based at least in part on the notify payload indicating prioritization; and
applying, via a WLAN access point to the subsequent signaling, the DSCP to the WLAN protocol mapping to prioritize the subsequent signaling between the WLAN access point and the UE.

15. An apparatus comprising:
processing circuitry to:
identify a multimedia priority service (MPS) indication included in a network access identifier (NAI) received from a user equipment (UE); and
handle the UE with priority based at least in part on the MPS indication; and
interface circuitry coupled with the processing circuitry, the interface circuitry to communicatively couple the processing circuitry with a component of a device.

16. The apparatus of claim 15, wherein the UE is handled with priority after the UE is authenticated.

17. The apparatus of claim 15, wherein the MPS indication is included in a username part of the NAI.

18. The apparatus of claim 15, wherein the processing circuitry is further to:
identify an indication of an establishment cause received from the UE; and
determine a differentiated services codepoint (DSCP) value for subsequent signaling of the UE based at least in part on the establishment cause.

19. The apparatus of claim 15, wherein the processing circuitry is further to:
generate a quality of service identifier (QI) to differentiated services codepoint (DSCP) mapping for subsequent signaling of the UE based at least in part on the MPS indication; and
apply, via a non-third generation partnership project internetworking function (N3IWF) or a trusted non-third generation partnership project gateway function (TNGF) to the subsequent signaling, the QI to DSCP mapping to prioritize the subsequent signaling between the N3IWF or the TNGF and a wireless local area network (WLAN) access point.

20. The apparatus of claim 15, wherein the processing circuitry is further to:
generate a differentiated services codepoint (DSCP) to a wireless local area network (WLAN) protocol mapping for subsequent signaling of the UE based at least in part on the MPS indication; and
apply, via a WLAN access point to the subsequent signaling, the DSCP to the WLAN protocol mapping to prioritize the subsequent signaling between the WLAN access point and the UE.
